(19) United States
(12) Patent Application Publication
(10) Pub. No.: US 2026/0044798 A1
(43) Pub. Date: Feb. 12, 2026

(54) METHOD AND SYSTEM FOR USING ROBOTIC PROCESS AUTOMATION TO PROVIDE REAL-TIME CASE ASSISTANCE TO CLIENT SUPPORT PROFESSIONALS

(71) Applicant: Rimini Street, Inc., Las Vegas, NV (US)

(72) Inventors: Praveen Sahni, Union City, CA (US); Nitin Kumar, Crace (AU); Elissa G. Klotz, Union, NJ (US)

(73) Assignee: Rimini Street, Inc., Las Vegas, NV (US)

(21) Appl. No.: 19/360,270

(22) Filed: Oct. 16, 2025

Related U.S. Application Data
(63) Continuation of application No. 17/680,584, filed on Feb. 25, 2022.
(60) Provisional application No. 63/154,390, filed on Feb. 26, 2021.

(51) Int. Cl. G06Q 10/0631; G06N 5/022

(52) U.S. Cl. CPC G06Q 10/06313; G06N 5/022; G06Q 10/063112

(57) ABSTRACT

A case assistant is provided to client support professionals, which utilizes robotic process automation (RPA) technologies to analyze large amounts of data related to historical client cases that are similar to current open cases, data related to skilled experts associated with similar client cases, and data related to business exceptions. Several processes are utilized to provide this data to client support professionals, including a document similarity finder that utilizes a vector data collector, a tokenizer, a stop word remover, a relevance finder, and a similarity finder, several of which utilize a variety of machine learning technologies. Additional processes include a skilled experts finder and a business exceptions finder.

### RELATED APPLICATIONS

This application is a continuation of U.S. patent application Ser. No. 17/680,584, filed in the name of Praveen Sahni et al. on Feb. 25, 2022, entitled “METHOD AND SYSTEM FOR USING ROBOTIC PROCESS AUTOMATION TO PROVIDE REAL-TIME CASE ASSISTANCE TO CLIENT SUPPORT PROFESSIONALS,” which claims the benefit of U.S. Provisional Patent Application No. 63/154,390, filed in the name of Praveen Sahni on Feb. 26, 2021, entitled “METHOD AND SYSTEM FOR USING ROBOTIC PROCESS AUTOMATION TO PROVIDE CASE ASSISTANCE TO CLIENT SUPPORT PROFESSIONALS,” both of which are hereby incorporated by reference in their entirety as if they were fully set forth herein.

This application is related to U.S. patent application Ser. No. 16/195,668, filed in the name of Praveen Sahni et al. on Nov. 19, 2018, entitled “METHOD AND SYSTEM FOR PROVIDING A MULTI-DIMENSIONAL HUMAN RESOURCE ALLOCATION ADVISER,” which issued as U.S. Pat. No. 11,182,707 on Nov. 23, 2021, and is hereby incorporated by reference in its entirety as if it were fully set forth herein.

### BACKGROUND

One of the major challenges facing businesses, and particularly businesses that provide professional services to clients, is finding ways to effectively and efficiently utilize the businesses' resources and data assets to improve the quality and speed of case resolution. Many businesses providing professional services to clients employ thousands of client support professionals, and have a vast client base consisting of clients utilizing thousands of specialized technical products and product modules. Thus the client support professionals employed by these businesses are often highly skilled and/or specialized personnel, such as engineers, technicians, or other technical professionals.

In order to resolve client cases, many businesses utilize one or more traditional client service systems or client management systems to collect, track, and analyze data about various jobs, tasks, and projects performed by their employees. Using these traditional client service systems, when a client has a project or an issue that needs resolution, a client case is created within the system, case data is collected, and each case is tracked until the case is resolved or finished. However, traditional client service systems have a number of technical drawbacks, which prevent them from being able to utilize the full potential of the business' resources and data assets.

Enabling effective and efficient case resolution requires providing client support professionals with real-time case assistance that takes into consideration a wide variety of distinct, yet interconnected factors related to resolution of client cases. Most traditional and current client service systems lack the technical capability to analyze and process the subtle and highly complex interconnections between these factors, in a way that provides practical and concrete real-world, real-time results. For example, not only does effective and efficient case resolution require detailed real-time analysis of vast quantities of dynamically changing skill set data for both individual support professionals and teams of support professionals, it also requires detailed real-time analysis of vast quantities of relevant case history data, data related to past, current, and potential employee collaboration opportunities, data related to business execution exceptions, identification of potential skill gaps and potential solutions, as well as identification of case problem scope and proactive case resolution opportunities, all of which are beyond the capacity of the human mind to comprehend. Thus, development of effective and efficient systems and methods to assist client support professionals with case resolution in real-time is a highly complex and challenging technical problem, which requires a technical solution.

As one specific illustrative example, a service provider that provides a variety of support services for various Enterprise Resource Planning (ERP) related software systems utilized by clients can potentially have hundreds of clients, with data repositories containing thousands of case records associated with jobs performed for each of those clients. Efficient resolution of open cases often hinges on being able to rapidly identify closed case records that are similar to open case records. Further, each case may require numerous and varied skills to resolve, and identifying client support professionals best suited to assist with open cases can be a daunting, if not impossible task.

Consider a business employing engineering professionals to provide clients of the business with engineering and support services for various Enterprise Resource Planning (ERP) related systems utilized by those clients. In this specific illustrative example, each engineering professional potentially has numerous specialized skills and experience with numerous specific products, product modules, and the features and capabilities associated with those products and product modules. Further, the specialized skills of each engineering professional are not static. As each engineer works on various cases, they are constantly developing new skills, both on and off the job, and thus in many situations, it is not possible for the human mind to detect, process, and track the continuously changing skill sets of the engineering professionals. Given that each engineering professional can have potentially hundreds of skills associated with potentially hundreds of products and product sub-systems, it is often the case that a single engineering professional's skill set can include hundreds, or even thousands, of individual, dynamically changing, skills.

Additionally, the problem becomes even more complex when more than one client support professional needs to be assigned to a client case. Consider a client case that requires a team of ten employees to resolve. Not only does the skill set data for each of the individual client support professionals need to be analyzed, but the skill set data for each of the individual client support professionals needs to be analyzed in relation to the skill set data for each of the other individual client support professionals. Additionally, other factors besides skill sets need to be accounted for, such as, but not limited to, case history data related to past performance of client support professionals on cases previously worked in combination with other professionals, as well as exceptions that may occur related to support professional workload and availability. Consequently, developing effective and efficient systems and methods to assist client support professionals with case resolution in real-time can rapidly become a complicated and daunting technical task, which is not capable of being performed by the human mind, especially given the fixed nature of traditional data processing systems.

Indeed, the technical problem can be so complex that it is not practical, and in most cases not possible, for a human being to accurately identify and comprehend the interaction and relationships between the skill sets of multiple, even thousands, of support professionals, each having potentially hundreds, or even thousands, of individual, dynamically changing skills, and the requirements of multiple, even thousands, of projects/cases for potentially hundreds of clients of the business, each of these projects/cases in turn having potentially hundreds, or even thousands, of job skill set requirements and contract performance requirements and limitations. In addition, the problem becomes even more complicated when availability and workload for each qualified support professional must also be taken into account.

The result is a problem complexity that makes it impossible for a human being to recognize significant relationships and interconnections between all of the factors necessary to effectively and efficiently provide real-time case assistance to client support professionals such that the client support professionals can more rapidly and successfully resolve client cases. As noted above, the current technical problem of effectively and efficiently providing real-time case assistance to client support professionals is an on-going and dynamically changing problem due, in part, to the fact that the client support professionals employed by many businesses have skill sets and experience that are constantly changing as the professionals are assigned to various projects and complete various tasks, thereby obtaining new skills and valuable experience.

The current difficulty encountered when trying to effectively and efficiently provide real-time case assistance to client support professionals is not only problematic for the businesses desiring to enhance the productivity of their employees, but is also problematic for the clients of the businesses, in that failing to effectively and efficiently provide case assistance to client support professionals can adversely impact the quality of the work performed and the time it takes to complete that work. Consequently, the long-standing technical problem of a lack of effective and efficient systems and methods for providing real-time case assistance to client support professionals is a detriment to the business employer, as well as to the employees and clients of that business, potentially resulting in missed deadlines and benchmarks, lost man-hours, cost overruns, and lower quality work. Furthermore, the above-described difficulties are often amplified by various on-going labor shortages.

What is needed therefore, is a technical solution to the long-standing technical problem of effectively and efficiently providing real-time case assistance to client support professionals, to enhance the ability of the professionals to more rapidly and successfully resolve client cases.

### SUMMARY

Embodiments of the present disclosure provide a technical solution to the technical problem of effectively and efficiently providing real-time case assistance to client support professionals, to enhance the ability of the professionals to more rapidly and successfully resolve client cases.

The embodiments disclosed herein provide a case assistant system which utilizes Robotic Process Automation (RPA) technologies in combination with Machine Learning (ML) technologies to assist and advise support professionals on relevant similar client case history, initiate collaboration between support professionals, and advise support professionals on skills needed for particular client cases. The case assistant is also able to raise execution exceptions, such as, but not limited to, alerting a team owner or team leader when support professionals are out of the office, have left the company, and/or are impacted by regional emergency conditions.

Thus, the disclosed embodiments represent a technical solution to the long-standing technical problem of providing real-time case assistance to client support professionals by utilizing RPA technologies in combination with ML technologies to proactively advise professionals on relevant similar case history, initiate collaboration among professionals, advise teams about skill gaps, create teams, and raise execution exceptions. Consequently, using the disclosed embodiments, the contributions of the professionals are accelerated and enhanced, thus allowing the support professionals to more rapidly and successfully resolve client cases.

Many traditional businesses utilize business process automation (BPA) technologies to streamline business processes, increase service quality, and contain business operating costs, however BPAs have a number of deficiencies when it comes to their ability to handle extremely complex problems such as those discussed above. For example, most BPAs are fully programmed in advance, are relatively static, and are not readily able to adapt themselves to unknown situations and unforeseen circumstances.

One emerging field within BPA is robotic process automation (RPA), which typically utilizes Machine Learning (ML) and Artificial Intelligence (AI) to address the deficiencies of traditional BPAs. Embodiments of the present disclosure take advantage of RPA technologies to solve the technical problem of providing real-time case assistance to client support professionals, as will be discussed in additional detail below.

In one embodiment, a computing system implemented method provides a client support professional with a user interface to a client service system containing case data associated with one or more clients of a service provider, obtains current open case data representing a current open case assigned to the client support professional, obtains historical closed case data representing historical closed cases associated with the service provider, trains one or more RPA workers to process the current open case data and the historical closed case data using one or more machine learning processes, and configures the one or more trained RPA workers to process the current open case data and the historical closed case data.

In one embodiment, the configured trained RPA workers perform one or more of: identifying historical closed cases that are similar to the current open case, and generating ranked similar case data; identifying experts that are skilled with the historical closed cases that are similar to the current open case and generating ranked skilled experts data; identifying business execution exceptions associated with the current open case and generating business exceptions data; and providing the client support professional with data related to one or more of similar cases, skilled experts, and business exceptions through the user interface of the client service system.

In one embodiment, the functions of the configured trained RPA workers are performed in near real-time. In one embodiment, the historical closed case data representing historical closed cases associated with the service provider includes data associated with one hundred or more historical closed cases.

In one embodiment, identifying historical closed cases that are similar to the current open case, and generating ranked similar case data further includes: aggregating, processing, and filtering the obtained current open case data to generate aggregated open case vector data; aggregating, processing, and filtering the obtained historical closed case data to generate aggregated closed case vector data; parsing the aggregated open case vector data into tokens to generate tokenized open case vector data; parsing the aggregated closed case vector data into tokens to generate tokenized closed case vector data; identifying tokens of the tokenized open case vector data that will not be useful in determining the context of the current open case represented by the current open case data and generating filtered open case vector data; identifying tokens of the tokenized closed case vector data that will not be useful in determining the context of the historical closed case represented by the historical closed case data and generating filtered closed case vector data; assigning a relevance weight to each token of the filtered open case vector data to generate weighted open case vector data; assigning a relevance weight to each token of the filtered closed case vector data to generate weighted closed case vector data; providing one or more similarity processes with the weighted open case vector data and the weighted closed case vector data to generate a list of historical closed cases that are similar to the current open case; assigning each historical closed case in the list of similar historical closed cases a similarity ranking; and generating ranked similar case data.

In one embodiment, one or more machine learning models are trained to perform one or more of: identifying tokens of the tokenized open case vector data that will not be useful in determining the context of the current open case represented by the current open case data; identifying tokens of the tokenized closed case vector data that will not be useful in determining the context of the historical closed case represented by the historical closed case data; assigning a relevance weight to each token of the filtered open case vector data; assigning a relevance weight to each token of the filtered closed case vector data; and assigning each historical closed case in the list of similar historical closed cases a similarity ranking.

In one embodiment, identifying tokens of the tokenized open case vector data that will not be useful in determining the context of the current open case represented by the current open case data, and identifying tokens of the tokenized closed case vector data that will not be useful in determining the context of the historical closed case represented by the historical closed case data includes utilizing machine learning techniques to build one or more customized stop word removal processes.

In one embodiment, utilizing machine learning techniques to build one or more customized stop word removal processes includes one or more of: training one or more machine learning models to identify tokens in the tokenized open case vector data that should be removed from the generated filtered open case vector data; training one or more machine learning models to identify tokens that should not have been removed from the tokenized open case vector data and adding these tokens to the generated filtered open case vector data; training one or more machine learning models to identify tokens in the tokenized closed case vector data that should be removed from the generated filtered closed case vector data; and training one or more machine learning models to identify tokens that should not have been removed from the tokenized closed case vector data and adding these tokens to the generated filtered closed case vector data.

In one embodiment, assigning a relevance weight to each token of the filtered open case vector data and assigning a relevance weight to each token of the filtered closed case vector data includes utilizing machine learning techniques to build one or more customized relevance finder processes.

In one embodiment, utilizing machine learning techniques to build one or more customized relevance processes includes one or more of: utilizing TF-IDF techniques to train one or more machine learning models to identify tokens in the filtered open case vector data that should be assigned a higher or lower relevance value than other tokens in the filtered open case vector data; utilizing TF-IDF techniques to train one or more machine learning models to identify tokens in the filtered closed case vector data that should be assigned a higher or lower relevance value than other tokens in the filtered closed case vector data; training one or more machine learning models to identify tokens in the filtered open case vector data that should be assigned a higher or lower relevance value than other tokens in the filtered open case vector data based on identified business context of the tokens; and training one or more machine learning models to identify tokens in the filtered closed case vector data that should be assigned a higher or lower relevance value than other tokens in the filtered closed case vector data based on identified business context of the tokens.

In one embodiment, the one or more similarity processes include: a Cosine Similarity algorithm; a Jaccard Similarity algorithm; and an LSA Similarity algorithm. In one embodiment, the similarity algorithm used to generate the list of historical closed cases that are similar to the current open case is selected dynamically during data processing. In one embodiment, the similarity process is dynamically selected based on one or more of: the context of the current open case; the context of the historical closed case; the number of current and historic case documents being compared; the size of each of the current and historic case documents being compared; the number of pages in each of the current and historic case documents being compared; the number of paragraphs in each of the current and historic case documents being compared; the number of words in each of the current and historic case documents being compared; the file type of each of the current and historic case documents being compared; and the number of relevant words that were found for each of the current and historic documents being compared.

In one embodiment, identifying experts that are skilled with the historical closed cases that are similar to the current open case and generating ranked skilled experts data further includes: obtaining initial employee skill set data, dynamic employee skill set data, and employee HR data; aggregating the initial employee skill set data, the dynamic employee skill set data, and the employee HR data to generate aggregated employee skill set data; obtaining client data for the client associated with the current open case; processing the current open case data and the client data to generate current open case skill set vector data; processing the aggregated employee skill set data and the current open case skill set vector data to generate initial skill set matched employee data representing one or more skill set matched employees; for each skill set matched employee, generating normalized employee skill set vector data based on normalized employee skill set data and skill set features associated with the skill set matched employee; providing the normalized employee skill set vector data for each skill set matched employee and the current open case skill set vector data to a machine learning process to generate ranked skill matched employee data; and merging the ranked skill matched employee data with the ranked similar case data to generate ranked skilled experts data.

In one embodiment, the process for generating ranked similar case data described above can be performed and utilized independently of other case assistant functions. In one embodiment, all or some of the case assistant functions discussed herein can be accomplished without the need for specifically trained and configured RPA workers.

In various embodiments, a document similarity finder disclosed herein is comprised of several process sub-systems, which may include processes such as, but not limited to, a vector data collector, a tokenizer, a stop word remover, a relevance finder, and a similarity finder.

In one embodiment, the vector data collector of the document similarity finder is the core integration program that collects document data from the source systems for the defined vectors. In one embodiment, the tokenizer parses a document, paragraph, or a sentence into smaller units, called tokens, which include units comprised of one or more of individual words, groups of words, or terms and phrases. In one embodiment, the stop word remover filters out the words that are not important in the derivation of case context. In one embodiment, the relevance finder assigns a number between 0-1 to each contextual token identified in the previous step, based on how relevant the token is in the document. In one embodiment, the similarity finder is utilized to determine similarity between case documents.

In one embodiment, the stop word remover of the case assistant process includes a two-pass process. The first pass of the stop word remover utilizes NLTK (Natural Language Tool Kit) functions to remove the stop words. The second pass of the stop word remover utilizes supervised learning methods to train a model to build a continuously expanding “Ignore List.” In one embodiment, the second pass of the stop word remover also includes a “Qualifier List,” which adds business context words that may have been ignored in the first pass of the stop word remover.

In one embodiment, the relevance finder of the case assistant process includes a two-pass process. The first pass of the relevance finder uses TF-IDF (Term Frequency—Inverse Document Frequency) processes to assign an initial weight to the tokens not filtered out from the stop word remover. The second pass of the relevance finder passes the token weight list created by the first pass of the relevance finder to a “Business Context Enrichment” process for further refining the weight of the tokens.

In one embodiment, the similarity finder dynamically selects a similarity finding process from a set of two or more similarity finding processes based on factors such as, but not limited to, the document size, document type and TF_IDF match value. Examples of similarity finding processes dynamically selected by the similarity finder include, but are not limited to, processes that utilize the Cosine Similarity algorithm, Latent Semantic Analysis (LSA) Similarity algorithm and the Jaccard Similarity algorithm.

In various embodiments, the stop word remover, relevance finder, and similarity finder each utilize machine learning techniques to train a variety of machine learning models. In one embodiment, a variety of training user interfaces are provided to enable users to supervise the training processes. One or more end-user interfaces are also provided to present the results of the case assistant processes and sub-systems to an end-user, such as, but not limited to, a client support professional.

Thus, the disclosed embodiments represent a technical solution to the long-standing technical problem of providing real-time case assistance to client support professionals by utilizing RPA technologies to proactively advise professionals on relevant similar case history, initiate collaboration among professionals, advise teams about skill gaps, and raise execution exceptions.

Consequently, using the disclosed embodiments, the contributions of the professionals are accelerated and enhanced, thus allowing the support professionals to more rapidly and successfully resolve client cases.

### BRIEF DESCRIPTION OF THE DRAWINGS

FIG. 1A is a high-level diagram showing how a case assistant system builds upon an existing AI applications platform, in accordance with one embodiment.

FIG. 1B is a high-level diagram showing the case assistant system and AI applications platform as part of a larger architectural context, in accordance with one embodiment.

FIG. 2A is a block diagram of a production environment associated with a case assistant system, in accordance with one embodiment.

FIG. 2B is a block diagram of a production environment associated with a case assignment advisor utilized by a case assistant system, in accordance with one embodiment.

FIG. 3A is block diagram of a document similarity finder of a case assistant system, in accordance with one embodiment.

FIG. 3B is a block diagram of a stop word remover used by a document similarity finder of a case assistant system, in accordance with one embodiment.

FIG. 3C is a block diagram of a relevance finder used by a document similarity finder of a case assistant system, in accordance with one embodiment.

FIG. 3D is an illustrative representation of cosine similarity measurements, in accordance with one embodiment.

FIG. 3E is an illustrative depiction of a vector space model used to detect word similarity, in accordance with one embodiment.

FIG. 3F is an illustrative example of training data utilized by a relevance finder and a similarity finder, in accordance with one embodiment.

FIG. 4A is a flow chart of a process for providing case assistance to client support professionals, in accordance with one embodiment.

FIG. 4B is a flow chart of a process for identifying similar cases, in accordance with one embodiment.

FIG. 4C is a flow chart of a process for identifying skilled experts, in accordance with one embodiment.

FIG. 5 is an example screenshot of a rules and constraints configuration interface which may be utilized by a case assistant system, in accordance with one embodiment.

FIG. 6 is a screenshot of a business alerts configuration interface of a business exception finder utilized by a case assistant system, in accordance with one embodiment.

FIG. 7A is a screenshot of a dashboard user interface for a case assistant system, in accordance with one embodiment.

FIG. 7B is an enlarged view of a portion of the example screenshot of FIG. 7A, in accordance with one embodiment.

FIG. 7C is an example screenshot of a case assistant widget being utilized as part of a larger client service system, in accordance with one embodiment.

FIG. 8A is a screenshot of an alert system associated with a document similarity finder, in accordance with one embodiment.

FIG. 8B is a screenshot of a listing of similar cases generated by a document similarity finder, in accordance with one embodiment.

FIG. 9A and FIG. 9B are screenshots of an alert system associated with a skilled expert finder, in accordance with one embodiment.

FIG. 9C is a screenshot of an interface for initiating collaboration with skilled experts, in accordance with one embodiment.

FIG. 9D is a screenshot of a listing of available skilled experts generated by a skilled expert finder, in accordance with one embodiment.

FIG. 9E is a screenshot of an interface for initiating collaboration with available skilled experts, in accordance with one embodiment.

FIG. 9F is a screenshot of an interface for viewing the skills of available skilled experts, in accordance with one embodiment.

FIG. 10A and FIG. 10B are screenshots of business exception alerts generated by a business exception finder, in accordance with one embodiment.

Common reference numerals are used throughout the figures and the detailed description to indicate like elements. One skilled in the art will readily recognize that the above figures are examples and that other architectures, modes of operation, orders of operation, elements, and functions can be provided and implemented without departing from the characteristics and features of the invention, as set forth in the claims.

### DETAILED DESCRIPTION

Embodiments will now be discussed with reference to the accompanying figures, which depict one or more exemplary embodiments. Embodiments may be implemented in many different forms and should not be construed as limited to the embodiments set forth herein, shown in the figures, and/or described below. Rather, these exemplary embodiments are provided to allow a complete disclosure that conveys the principles of the invention, as set forth in the claims, to those of skill in the art.

The embodiments disclosed herein provide a case assistant which utilizes Robotic Process Automation (RPA) technologies in combination with Machine Learning (ML) technologies to advise support professionals on relevant client case history, initiate collaboration between support professionals, and advise support professionals on skills needed for particular client cases. The case assistant is also able to raise execution exceptions, such as, but not limited to, alerting a team owner or leader when support professionals are out of the office or have left the company.

Many traditional businesses utilize business process automation (BPA) technologies to streamline business processes, increase service quality, and contain business operating costs, however, as discussed above, BPAs have a number of deficiencies when it comes to their ability to handle extremely complex problems such as those discussed above. For example, most BPAs are fully programmed in advance, are relatively static, and are not readily able to adapt themselves to unknown situations and unforeseen circumstances.

One emerging field within BPA is robotic process automation (RPA), which typically utilizes Machine Learning (ML) and Artificial Intelligence (AI) to address the deficiencies of traditional BPAs. Embodiments of the present disclosure take advantage of RPA technologies to solve the technical problem of providing real-time case assistance to client support professionals, as will be discussed in additional detail below.

As used herein, the term “real-time” may be used interchangeably with the term “near real-time” and as such, processes performed by the disclosed embodiments may include processes performed in minutes, seconds, milliseconds, microseconds, nanoseconds, or any other time frame in which a CPU is capable of processing data currently and/or as made available after the time of filing.

Thus, the disclosed embodiments represent a technical solution to the long-standing technical problem of providing real-time case assistance to client support professionals by utilizing RPA technologies to proactively advise professionals on relevant case history, initiate collaboration among professionals, advise teams about skill gaps, and raise execution exceptions. Consequently, using the disclosed embodiments, the contributions of the professionals are accelerated and enhanced, thus allowing the support professionals to more rapidly and successfully resolve client cases.

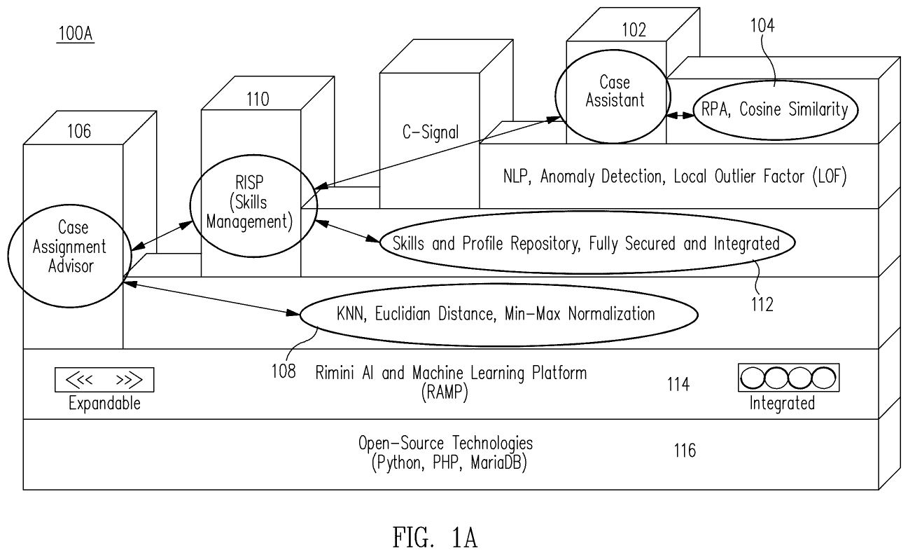

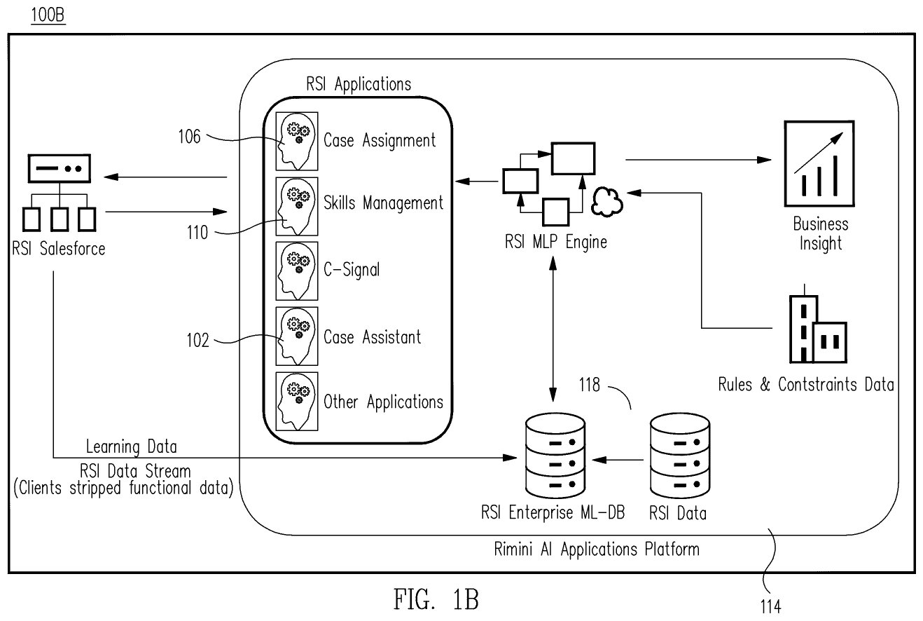

FIG. 1A is a high-level diagram 100A showing how a case assistant system builds upon an existing AI applications platform, in accordance with one embodiment.

As shown in FIG. 1A, in one embodiment, case assistant system 102 utilizes skills manager 110 and case assignment advisor 106 to assist client support professionals, such as, but not limited to, engineers, in finding similar functional problems across cases, to identify and locate required team skills, to initiate collaboration with other support professionals, and to raise business exception alerts. As also shown in FIG. 1A, in one embodiment, a few case assistant tools 104 utilized by the case assistant system 102 are robotic process automation (RPA) and one or more processes, such as, but not limited to processes utilizing a cosine similarity algorithm. In one embodiment, skills manager 110 utilizes skills management tools 112, including, but not limited to, a fully secured and integrated skills and profile repository. In one embodiment, case assignment advisor 106 utilizes case assignment tools 108 which include a number of processes, such as, but not limited to k-nearest neighbors (KNN), Euclidean distance, and min-max normalization.

In various embodiments, case assistant system 102, skills manager 110, and case assignment advisor 106 are built upon expandable AI and machine learning platform 114, which utilizes a variety of open-source technologies 116 to provide case assistant system 102, skills manager 110, and case assignment advisor 106 with a sophisticated and unique machine learning engine. Additional details of each of the elements set forth above will be discussed in further detail below.

FIG. 1B is a high-level diagram 100B showing the case assistant system and AI applications platform as part of a larger architectural context, in accordance with one embodiment.

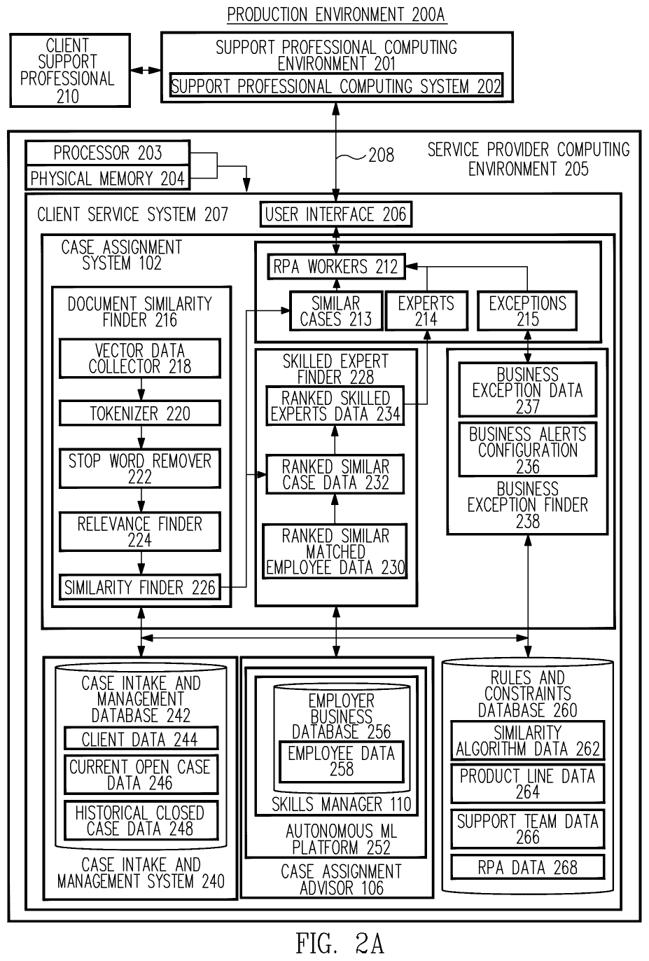

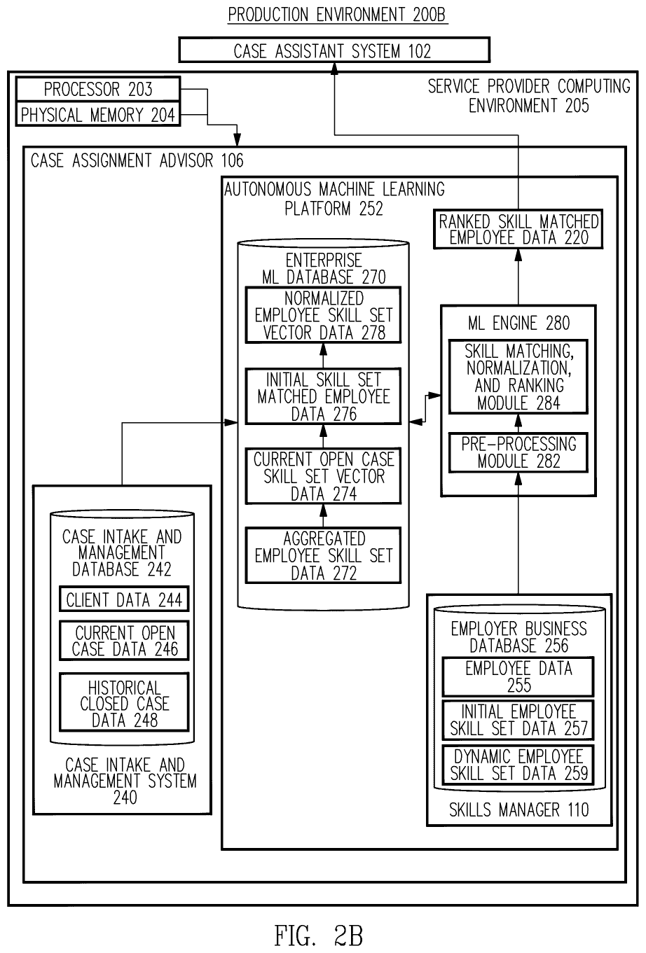

FIG. 1 and FIG. 2 together show an integrated, secured and extensible AI applications platform 114, which performs several functions. Firstly, in one embodiment, AI applications platform 114 integrates with multiple data sources, such as data sources 118. In one embodiment, AI applications platform 114 includes skills manager 110 and case assignment advisor 106, which together are able to capture multi-dimensional skills of support professionals, and use machine learning processes to normalize and rank the skills of support professionals to enable providing recommendations to match skills of the professionals with the skills best suited to resolve particular client cases. Additionally, in one embodiment, AI applications platform 114 proactively identifies “need attention” and “positive” signals for a business by analyzing data anomalies and user sentiments. In one embodiment, the applications platform 114 is an integrated and expandable platform, and further includes case assistant system 102, which is capable of incorporating new natural language processes and machine learning processes to perform tasks such as document similarity finding, skilled experts finding, and business exceptions finding, each of which will be discussed in additional detail below.

### System

FIG. 2A is a block diagram of a production environment 200A associated with a case assistant system, in accordance with one embodiment.

As shown in FIG. 2A, in one embodiment, production environment 200A includes client support professional 210, support professional computing environment 201, support professional computing system 202, and service provider computing environment 205. In one embodiment, service provider computing environment 205 includes processor 203, physical memory 204, one or more communications channels 208, and client service system 207. In one embodiment, client service system 207 includes user interface 206, case assistant system 102, case assignment advisor 106, case intake and management system 240, and rules and constraints database 260.

In one embodiment, case assistant system 102 includes document similarity finder 216, skilled expert finder 228, business exception finder 238, robotic process automation (RPA) workers 212, similar cases data 213, experts data 214, and exceptions data 215. In one embodiment, document similarity finder 216 includes vector data collector 218, tokenizer 220, stop word remover 222, relevance finder 224, and similarity finder 226. In one embodiment, skilled expert finder 228 includes ranked skill matched employee data 230, ranked similar case data 232, and ranked skilled experts data 234. In one embodiment, business exception finder 238 includes business alerts configuration 236 and business exception data 237.

In one embodiment, case intake and management system 240 includes case intake and management database 242, which further includes client data 244, current open case data 246, and historical closed case data 248. In one embodiment, case assignment advisor 106 includes autonomous machine learning (ML) platform 252. In one embodiment, autonomous ML platform 252 includes skills manager 110. In one embodiment, skills manager 110 includes employer business database 256. In one embodiment, employer business database includes employee data 258. In one embodiment, rules and constraints database 260 includes similarity algorithm data 262, product line data 264, support team data 266, and RPA data 268. Each of the above listed elements will be discussed in further detail below.

In one embodiment, case assistant system 102 utilizes one or more RPA workers 212. In the embodiments disclosed herein the term “RPA workers,” or “RPA processes,” includes background programs/processes that can be multiplied into hundreds or thousands or any number desired/needed, which can be executed continuously in the background of a service provider system to perform a wide variety of computing tasks. In one embodiment, the RPA workers can be easily cloned as the service provider platform is scaled. In one embodiment, the RPA workers can be configured, trained and controlled by business users of the service provider platform.

As discussed above, many traditional businesses utilize business process automation (BPA) technologies to streamline business processes, increase service quality, and contain business operating costs, however BPA technologies have a number of deficiencies associated with their ability to handle extremely complex problems such as those discussed above. For example, most BPA processes are fully programmed in advance to do a specific job, and as such, they are relatively static, and are not readily able to adapt themselves to unknown situations and unforeseen circumstances.

Unlike BPAs, RPA workers and/or processes are given instructions to do a job, and as they perform the job, they utilize a variety of machine learning techniques to learn while they are working, such that they are able to readily adapt themselves to unknown situations and unforeseen circumstances. While many applications utilize machine learning, most of these are front-end UI applications, whereas RPA workers are processes that are always running in the background of a system, such as client service system 207, learning autonomously and working to provide help to system users when necessary.

In relation to case assistant system 102, RPA workers 212 are trained and configured to perform a variety of jobs, including, but not limited to, identifying areas in which assistance can be provided to client support professional 210 through user interface 206, which in one embodiment, is accessible by client support professional computing system 202. In one embodiment, RPA workers 212 proactively provide assistance to client support professional 210 in real-time or near-real time.

For example, many service providers have thousands of open client cases that are worked on by hundreds of client support professionals every day. The case assistant system 102 enables training and configuring of RPA workers 212, such that RPA workers 212 can work continuously in the background of client service system 207 to help each client support professional, such as client support professional 210, with open client cases that have been assigned to the client support professionals. Because the RPA workers 212 are working continuously in the background, the client support professionals do not need to spend valuable time combing through thousands of historical documents in order to find the best solution to resolve an open case. The client support professionals, such as client support professional 210 can instead rely on RPA workers 212 of case assistant system 102 to discover relevant helpful information and bring it to the attention of client support professional 210 in real-time or near-real time. In one embodiment, the relevant helpful information includes similar cases data 213, which enables client support professionals to review root causes and solutions to similar, previously resolved cases that may be relevant to finding solutions to the current open case. In one embodiment, the relevant helpful information includes experts data 214, which identifies skilled experts that have previously resolved similar cases, which enables client support professionals to collaborate with other experts to more readily find solutions to the current open case. In one embodiment, the relevant helpful information includes exceptions data 215, which functions to alert client support professionals if team members become unavailable and need to be replaced in order to efficiently resolve the current open case.

In one embodiment, client support professional 210 is provided with data related to one or more of similar cases, skilled experts, and business exceptions in real-time through the user interface of the client support system to assist the client support professional with efficient resolution of the current open case. In one embodiment, jobs that are assigned to individual RPA workers 212, include jobs such as, but not limited to, finding historical closed case documents that are similar to current open cases assigned to client support professional 210, finding experts that are skilled in a particular technical area associated with the current open cases assigned to client support professional 210, and finding business execution exceptions and alerting client support professional 210 regarding the business exceptions. While these three job types will be discussed at length in the present disclosure, it should be appreciated that many additional job types can be assigned to RPA workers 212 as needed.

Thus, one RPA worker 212 can be configured to utilize document similarity finder 216 to generate similar cases data 213, one RPA worker 212 can be configured to utilize skilled expert finder 228 to generate experts data 214, and one RPA worker 212 can be configured to utilize business exception finder 238 to generate exceptions data 215, and additional RPA workers can be configured to perform other jobs as needed. These three or more RPA workers 212 can then be cloned at any desired quantity depending on factors such as, but not limited to, the overall case load being handled by client service system 207. RPA workers 212 can then proactively provide similar cases data 213, experts data 214, and exceptions data 215 to client support professional 210 through user interface 206 of client service system 207.

Consequently, utilization of RPA workers/processes results in increased efficiency, quality and scalability of the assistance provided, as disclosed herein, to client support professional 210 by case assistant system 102. In addition, although RPA workers are discussed herein at length, it should be clear to one of ordinary skill in the art that any type of processes, programs and/or functions that perform similar functions as RPA workers, as known at the time of this filing, and/or as later developed after the time of filing, can be utilized.

As shown in FIG. 2A, in one embodiment, case assistant system 102 assists client support professional 210 by providing valuable data in the form of similar cases data 213, experts data 214, and exceptions data 215. In one embodiment, similar cases data 213 is generated by document similarity finder 216, experts data 214 is generated by skilled expert finder 228, and exceptions data 215 is generated by business exception finder 238, each of which will be discussed in additional detail below.

In one embodiment, document similarity finder 216 of case assistant system 102 is utilized by one or more RPA workers 212 to alert support professionals, such as client support professional 210 on the existence of closed cases from one or more clients that are similar to open cases being worked by client support professional 210. In one embodiment, document similarity finder 216 of case assistant system 102 includes several process sub-systems, which together function to identify historical closed cases that are similar to current open cases being worked by client support professional 210. For example, in the embodiment depicted in FIG. 2A, document similarity finder 216 includes vector data collector 218, tokenizer 220, stop word remover 222, relevance finder 224, and similarity finder 226, each of which will be discussed in additional detail below.

In one embodiment, case intake and management system 240 represents one or more computing systems and databases through which sales personal for a service provider take in and record sales, track contracts and performance for both historical and current tasks, projects, or cases, coordinate new incoming tasks, projects, or cases, track on-going performance and milestones, record client feedback and satisfaction, and perform any other client intake and customer relations management functions as discussed or illustrated herein, and/or as known in the art at the time of filing, and/or as made known and/or available after the time of filing.

In one embodiment, case intake and management system 240 includes case intake and management database 242. In one embodiment, case intake and management database 242 includes historical closed case data 248. In one embodiment, historical closed case data 248 is aggregated data and includes case history data such as, but not limited to, closed case subject, closed case description, closed case abstract, product name associated with closed case, product line associated with closed case, modules, skills and experience associated with the closed case, closed case root cause, closed case solution, client support professionals responsible for resolving the closed cases, closed case communications and comments data, closed case resolution time, client associated with closed case, closed case client satisfaction review data, closed case client relations management data, and/or any other historical case data as discussed or illustrated herein, and/or as known in the art at the time of filing, and/or as made known and/available after the time of filing.

In one embodiment, case intake and management database 242 further includes current open case data 246. In one embodiment, current open case data 246 includes, but is not limited to, data representing: the name of the task, project, or case; the name of the client for which the task, project, or case is to be performed; the name of one or more client support professionals assigned to the task, the priority of the task, project, or case; the priority of the client associated with the task, project, or case; the job equipment type or product line associated with the task, project, or case; any subcomponents included with the job equipment type or product line associated with the task, project, or case; the type of task, project, or case; the complexity of the task, project, or case; whether the client associated with the task, project, or case is an escalated or strategic client; the average of any survey or review data associated with the client and/or task, project, or case; the geographic location of the client and/or where the task, project, or case is to be performed; the time zone associated with the location of the client and/or where the task, project, or case is to be performed; and/or any other current open case data as discussed or illustrated herein, and/or as known in the art at the time of filing, and/or as made available after the time of filing.

In one embodiment, case intake and management database 242 further includes client data 244. In one embodiment, client data 244 is aggregated client data and can include, but is not limited to, data representing: the name of the client; the priority of the client; the type of equipment or product lines associated with the client; any contractual obligations and/or requirements associated with the client and/or task, project, or case performed on behalf of the client; whether the client is an escalated or strategic client; the average of any survey or review data associated with the client; client relationship history; the geographic location of the client; the time zone associated with the location of the client; and/or any other client data as discussed or illustrated herein, and/or as known in the art at the time of filing, and/or as made available or known after the time of filing.

In one embodiment, all, or part of, the data stored in case intake and management database 242, including but not limited to, all, or part of, historical closed case data 248, current open case data 246, and client data 244 is provided for access and use by the other components of case assistant system 102, such as document similarity finder 216, skilled expert finder 228, and/or business exception finder 238.

In one embodiment, all, or part of, the data stored in case intake and management database 242, including but not limited to, all, or part of, historical closed case data 248, current open case data 246, and client data 244 is provided to document similarity finder 216 for the purpose of identifying historical closed cases that are similar to current open cases being worked by client support professional 210.

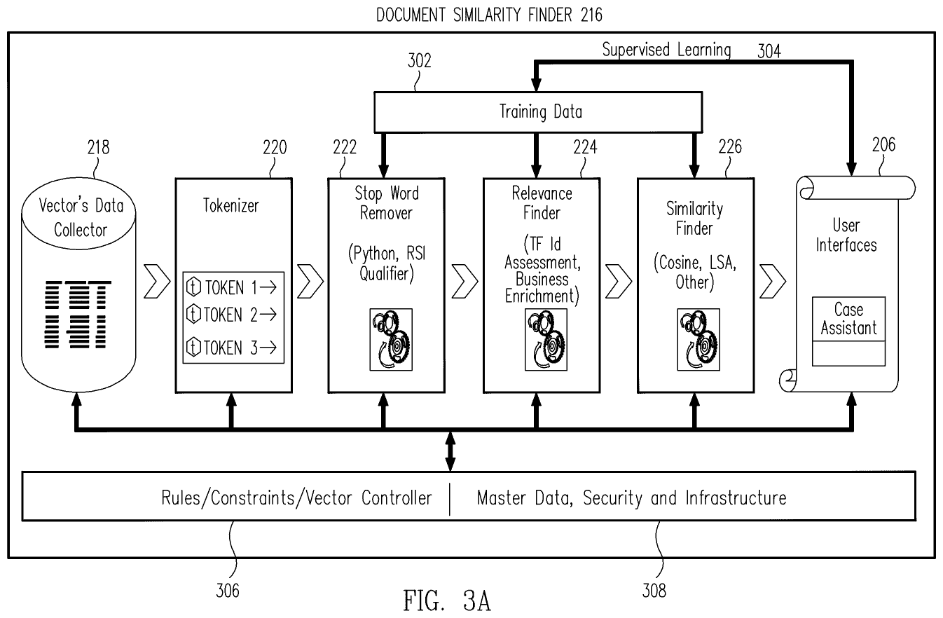

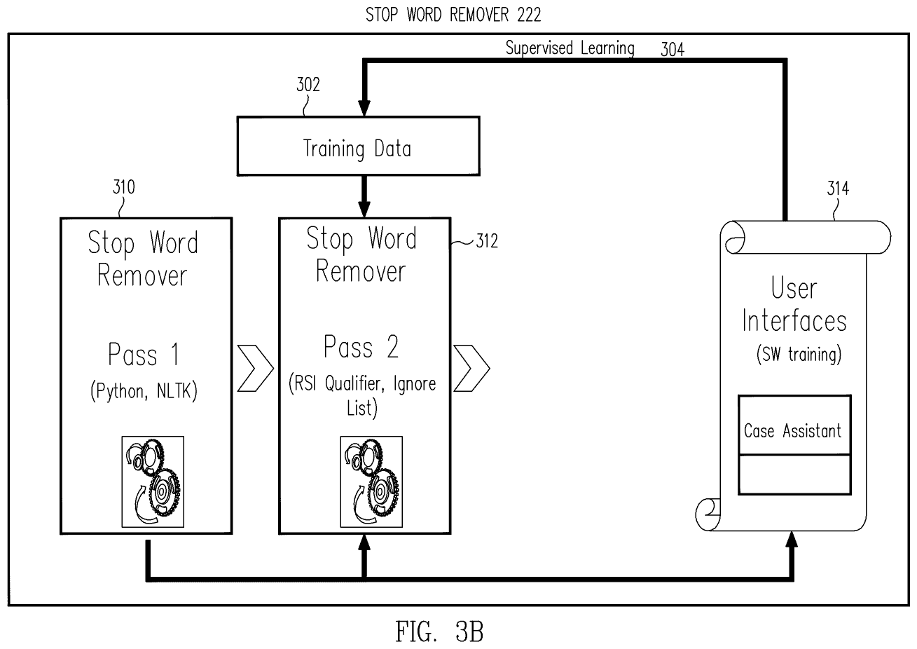

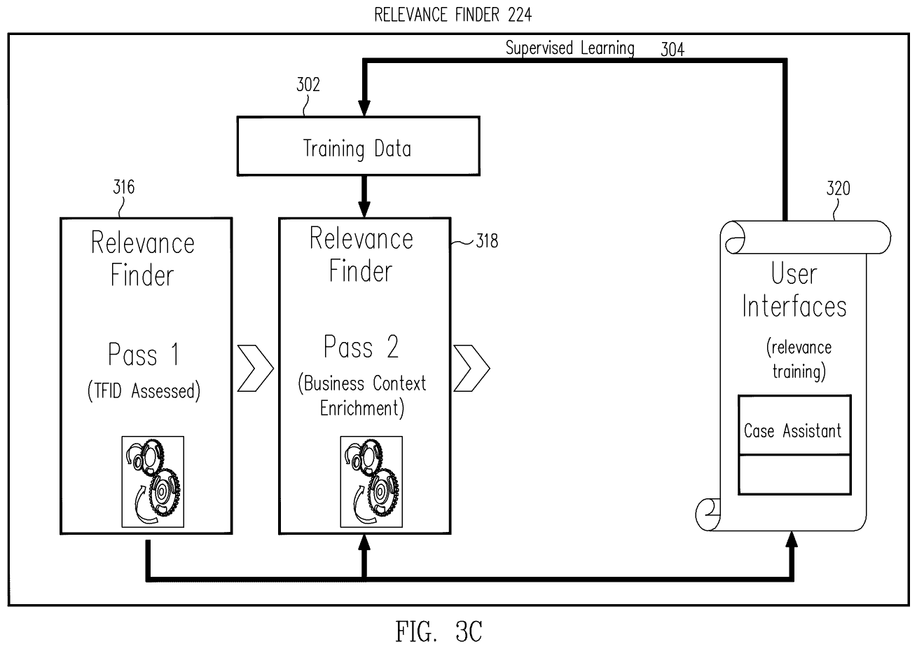

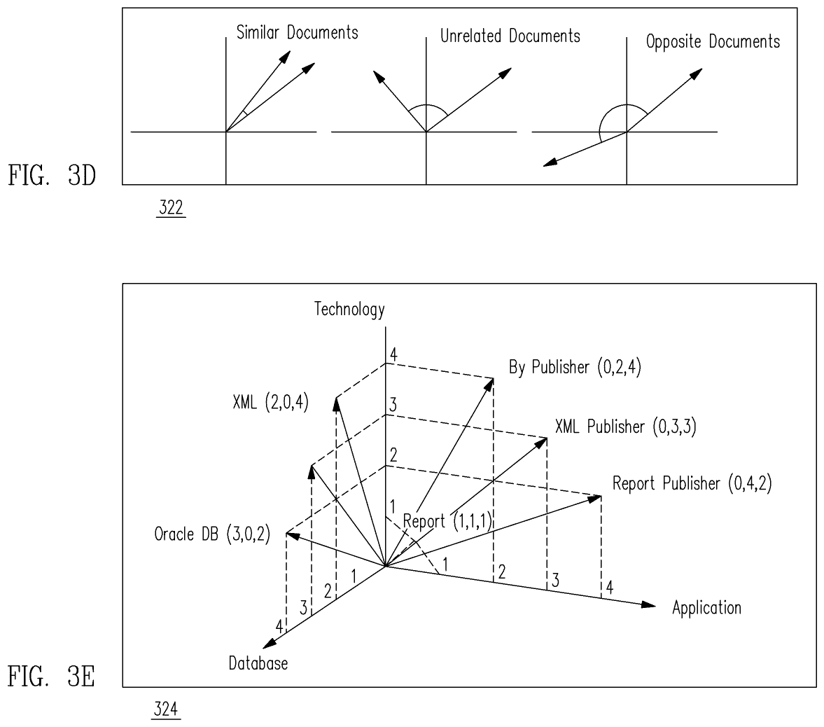

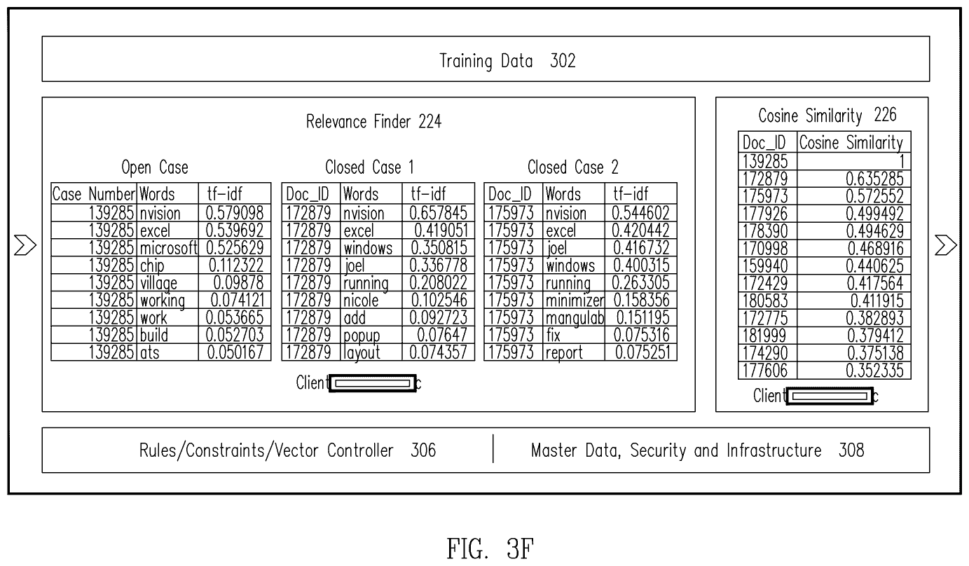

With respect to document similarity finder 216, details of the components of document similarity finder 216 will now be discussed herein in relation to FIG. 3A through FIG. 3F.

FIG. 3A is block diagram of a document similarity finder 216 of a case assistant system, in accordance with one embodiment.

Referring now to FIG. 2A and FIG. 3A, which together depict one embodiment of document similarity finder 216 of case assistant system 102, several sub-processes of document similarity finder 216 will now be discussed.

It should first be noted that historical closed case data 248 carries significant data value, which is often very beneficial for resolving the current open cases represented by current open case data 246, especially in the situation where current open case data 246 and historical closed case data 248 are associated with the same client represented by client data 244. Searching for valuable data assets from case intake and management database 242 and correlating current open case data 246 with the historical closed case data 248, is standard engineer's practice for understanding the background of current open cases. However, as discussed above, this practice can be extremely costly, time-consuming, and inefficient. Consequently, utilizing RPA workers 212 to proactively identify similar cases data 213 from processing historical closed case data 248 alongside current open case data 246, for cases associated with the client identified by client data 244, can result in identification of similar cases data 213, which, in one embodiment, can provide significant enhancements to the productivity of client support professional 210. As one illustrative example, as discussed above, RPA workers 212 can be configured to be always running in the background of client service system 207, looking for historical closed cases that are similar to a current open case being worked on by client support professional 210, so that client support professional 210 does not have to spend valuable time and energy manually looking for similar cases data 213.

In one embodiment, the RPA workers 212 continuously work in the background of a client service system to collect both case data and non-case data. In one embodiment, case/employee factors such as employee availability and workload are relevant to the functioning of case assistant system 102. In one embodiment, case/employee factors such as employee availability and workload are not relevant to the functioning of case assistant system 102. Whether or not individual case/employee factors are relevant to the proper functioning of case assistant system 102, in one embodiment, the aggregated case/employee/employer data is processed to generate vectors that can be useful for identifying similarity between documents, which assists client support professionals in efficiently and successfully resolving open cases.

Examples of potentially useful vectors and/or vector components/variables in the context of case assistant system 102 include but are not limited to: Dates and times of a client support professional's paid time off (PTO); attributes that define a client support professional's status as active or inactive; and/or attributes that define the case load and milestones of support professionals. Of particular importance to the document similarity finder 216 of case assistant system 102 is document abstract data retrieved from the case records, which in various embodiments includes data such as, but not limited to, case subject, case description, case size, case format, case solution, root cause, product name, and product module.

In the illustrative example provided by FIG. 3A, in one embodiment, a first sub-process of document similarity finder 216 includes vector data collector 218. In one embodiment vector data collector 218 accesses case intake and management system 240 of client service system 207. As noted above, in one embodiment, case intake and management system 240 includes case intake and management database 242. In one embodiment, case intake and management database 242 contains client data 244, current open case data 246, and historical closed case data 248.

In one embodiment, vector data collector 218 is the core integration program that collects data from source systems for several defined vectors. In various embodiments, vector data collector 218 not only collects/aggregates data, but also filters and formats the collected data. In one embodiment, vector data collector 218 analyzes and processes the data to determine which data elements are needed by the various machine learning components utilized by document similarity finder 216 of case assistant system 102. In one embodiment, vector data collector 218 retrieves data from case intake and management database 242. In one embodiment, data retrieved by vector data collector 218 may include data such as, but not limited to, details of clients and client cases, as represented by current open case data 246, historical closed case data 248, and client data 244.

In various embodiments, highly useful data is collected by vector data collector 218 from case intake and management database 242, such as data relating to particulars of case and client documents/records. In one embodiment, this data is derived from case documents/records that contain unformatted textual data. In one embodiment, vector data collector 218 aggregates and processes the unformatted textual data associated with current open case data 246, historical closed case data 248, and client data 244, such that the data can be more efficiently utilized by the various sub-systems and RPA workers/processes of case assistant system 102. In one embodiment processing the case and client data includes filtering and formatting the case and client data. In one embodiment, this data processing results in aggregated open case vector data and aggregated closed case vector data, which, in one embodiment, have been structured to provide the individual RPA workers with the specific data elements that they need in order to properly execute their assigned functions.

In one embodiment, once vector data collector 218 has aggregated, and processed the client and/or case data, to generate aggregated open case vector data and aggregated closed case vector data, vector data collector 218 then passes the aggregated open case vector data and aggregated closed case vector data to tokenizer 220, which parses the case vector data into individual tokens.

In one embodiment, tokenizer 220 parses a document, page, paragraph, or a sentence of aggregated closed case vector data and aggregated open case vector data into smaller units, such as individual words, groups of words, punctuation marks, numerical values and/or any other types of phrases and/or terms. In one embodiment word groupings may include bigrams (2 words) and/or trigrams (3 words). As discussed herein, each of these smaller units are called tokens. To optimize the performance of case assistant system 102, when a case is resolved/closed, relevant case data related to the now-closed case is transformed into historical closed case data 248. In one embodiment, both current open case data 246 related to open cases being worked by client support professional 210, and historical closed case data 248 related to previously closed cases are then passed to tokenizer 220. In this manner, whenever a case is closed, or whenever there is an update on a closed case, case assistant system 102 will automatically refresh the relevant case tokens. As one example, when and if a root cause or solution associated with a historical closed case is discovered, case assistant system 102 will update the historical closed case data 248 associated with the closed case. In one embodiment, updating of the historical closed case data 248 occurs in real-time or near real-time.

In one embodiment, while performing the parsing operation, tokenizer 220 removes many words that potentially do not provide value in terms of defining context of the data. Traditional tokenizers can be used for this purpose, however traditional tokenizers are not currently capable of reliably determining the context of the tokens in relation to the subject matter of the documents associated with current open case data 246 and historical closed case data 248. As one example, traditional tokenizers often leave in many words/tokens that are not actually useful in establishing business context, or they may remove words that actually are useful in establishing business context. As such, traditional tokenizers are not readily able to provide useful results in terms of processing tokens to identify business context of documents associated with case data. As will be discussed in additional detail below, establishing business context of documents and/or files associated with current and/or historical cases is an essential part of the invention disclosed herein.

In one embodiment, once the tokenizer 220 has finished parsing one or more documents into tokens, tokenized open case vector data and tokenized closed case vector data is then passed to stop word remover 222, which utilizes a unique two-pass process for removing words from the tokenized case vector data that are not useful in determining the business context of a case.

FIG. 3B is a block diagram of a stop word remover 222 used by document similarity finder 216 of a case assistant system, in accordance with one embodiment.

Referring now to FIG. 3A and FIG. 3B together, in various embodiments, stop word remover 222 of document similarity finder 216 includes a two-pass process. In one embodiment, the two-pass process includes stop word remover pass one 310, and stop word remover pass two 312. In one embodiment, stop word remover pass one 310 utilizes standard Natural Language Tool Kit (NLTK) functions to remove stop words from the token vectors received from tokenizer 220. As one illustrative example, in standard stop word removal we may have list A, which is then fed to an ML model to get list B, which is a more meaningful subset of list A. This standard stop word removal provides a reasonable filter as a first level of stop word removal. However standard stop word removal still fails to provide quality results in terms of reliably identifying tokens that will be useful for establishing the business context of a case. Therefore, to optimize the performance of stop word remover 222, stop word remover pass two 312 is designed to utilize supervised machine learning (ML) techniques 304 along with training data 302 to train an ML model with “Ignore List” building. The “Ignore List” functions to remove additional irrelevant or less important tokens from the case data, which may have been overlooked by stop word remover pass one 310. Utilizing supervised machine learning techniques 304 along with training data 302 allows the “Ignore List” to continuously learn and expand as the stop word remover 222 is used with more and more cases and the ML model grows more and more sophisticated as it continues to be trained. In one embodiment, stop word remover pass two 312 also includes a “Qualifier List,” which does the opposite of the “Ignore List” and adds business context words that may have been erroneously ignored in the first automated pass. In various embodiments, stop word remover 222 further includes stop word training user interface 314, which allows users to supervise the training process.

Returning now to FIG. 3A, in one embodiment, once stop word remover 222 has filtered the tokenized open case vector data and the tokenized closed case vector data based on the unique two-step process, stop word remover 222 then passes the resulting filtered open case vector data and filtered closed case vector data to relevance finder 224, which, in one embodiment, includes a unique two-pass process for identifying the business context of the closed and open cases represented by the filtered open case vector data and the filtered closed case vector data.

FIG. 3C is a block diagram of a relevance finder 224 used by document similarity finder 216 of a case assistant system, in accordance with one embodiment.

Referring now to FIG. 3A and FIG. 3C together, in various embodiments, relevance finder 224 of document similarity finder 216 also includes a two-pass process. In one embodiment, the two-pass process utilized by relevance finder 224 includes relevance finder pass one 316, and relevance finder pass two 318. This two-pass process assigns a relevance weight, which in some embodiments, is number between 0-1, to each contextual token identified by stop word remover 222, based on how relevant the token is in the document.

In one embodiment, relevance finder pass one 316 uses term frequency-inverse document frequency (TF-IDF) to identify the initial weight of the tokens of the filtered open case vector data and the filtered closed case vector data. TF-IDF looks at factors such as how many times a particular word or phrase is utilized in the document, as well as associations between words. For example, context is built based not just on how many times the word is there, but also on whether there are any relevant words that are setting the context. As one illustrative example, suppose two tokens are “spreadsheet” and “Microsoft Excel.” TF-IDF looks at semantic associations between these tokens to determine relevancy, and relates the words in a cosine similarity space to find relevant similar words. Stop word remover pass one 316 then generates a token weight list, and passes the token weight list to relevance finder pass two 318.

In one embodiment, relevance finder pass two 318 passes the token weight list generated by relevance finder pass one 316 to a “Business Context Enrichment” process for further refining the weight of the tokens. For example, if a token is an Enterprise Resource Planning (ERP) product/module name, a form name, a report name, or a process name, the weight of these tokens is increased by relevance finder pass two 318, because these types of tokens define more precise business context of the problem. For example, a token including an ERP product/module name is likely more relevant in the context of a problem or solution match compared with a token such as ‘spreadsheet’ or ‘log file.’

In one embodiment, supervised learning methods 304 and training data 302 are utilized to enrich the business context list. Relevance training user interface 320 is designed to provide users an option to feed (or tag) business words as and when they are encountered and not present in the existing business context list. In various embodiments, the initial business context list contains thousands of product and module names known to be supported by the business. In one embodiment, relevance finder 224 generates weighted open case vector data and weighted closed case vector data, which is then passed to similarity finder 226 of document similarity finder 216.

Returning now to FIG. 3A, in one embodiment, similarity finder 226 utilizes one or more similarity finding processes to transform the weighted open case vector data and the weighted closed case vector data into a ranked listing of historical closed cases that are similar to open cases being worked by client support professionals. In various embodiments, similarity finder 226 is an important process in finding historical closed cases that are similar to current open cases. In one embodiment, only cases from the same client are considered when identifying similar documents. In one embodiment, cases associated with multiple clients may be considered when identifying similar documents. In one embodiment, similarity finder 226 ranks the historical closed cases from highest to lowest in similarity, where a ranking of 1=100% similarity, and a ranking of 0=0% similarity. In one embodiment, a similarity threshold value is set to determine a similarity value needed for document similarity finder 216 to suggest a similar case to a client support professional.

In various embodiments, the accuracy of document similarity finder 226 largely depends upon the quality of tokens and their weights generated from the previous document similarity finder 216 operations, as represented by the weighted open case vector data and the weighted closed case vector data generated by relevance finder 224. The accuracy of document similarity finder 226 also depends on how the bi-grams (2 words) and tri-grams (3 words) tokens are constructed, as the business context is often defined only by how words such as “Sales Order” or “Purchase Order” are streamed and always kept together.

In one embodiment, the data is segregated to improve performance of similarity finder 226. For example, if similarity finder 226 has thousands of cases to evaluate, similarity finder 226 will first look into cases associated with the same product name, as the chances of finding similar business contexts are higher for cases associated with the same product name. In one embodiment, if case documents meeting the similarity threshold are not found for cases with the same product name, similarity finder 226 may then look at cases within the same product line, etc.

In one embodiment, the design of similarity finder 226 is largely based on dynamic selection of a similarity finding process. While a similarity finding process can be manually selected, similarity finder 226 is also able to dynamically select the best similarity finding process to use based on factors such as, but not limited to, the context of the case problem, the number of documents being compared, the size of each document, the number of pages in each document, the number of paragraphs in each document, the number of words in each document, the file type of each document, as well as the number of relevant words that were found by relevance finder 224 for each document.

For example, one type of similarity finding process may work best for large documents, while a different similarity finding process may work best for small documents. Alternatively, or additionally, one similarity finding process might give better results when the number of relevant words found is high, while a different similarity finding process might give better results when the number of relevant words found is low. In various embodiments, the ML models utilized by similarity finder 226 select the similarity finding process from the following options dynamically: Cosine Similarity algorithm; Jaccard Similarity algorithm; and LSA Similarity algorithm. In various other embodiments, other algorithms and/or processes, as discussed herein, and/or as known in the art at the time of filing, and/or as developed or made known after the time of filing can be utilized to determine similarity between case documents.

FIG. 3D is an illustrative representation of cosine similarity measurements 322, in accordance with one embodiment.

In various embodiments, the Cosine Similarity algorithm measures the cosine of the angle between two vectors projected in a multi-dimensional space, where the lesser the angle between the two vectors is, the more similar the subject matter is. One version of a Cosine Similarity mathematical formula utilized by some embodiments of the present disclosure is:

$${a}^{\text{?}} \cdot {b}^{\text{?}} = ‖ {a}^{\text{?}} ‖ ‖ {b}^{\text{?}} ‖ cos θ$$

$$cos θ = \frac{{a}^{\text{?}} \cdot {b}^{\text{?}}}{‖ {a}^{\text{?}} ‖ ‖ {b}^{\text{?}} ‖}$$

$$\text{?} \text{indicates text missing or illegible when filed}$$

FIG. 3E is an illustrative depiction of a vector space model 324 utilized to detect token similarity, in accordance with one embodiment.

In various embodiments, the Jaccard Similarity algorithm measures similarity between two finite sample sets by taking the ratio of Intersection over Union, which in one embodiment is defined as size of intersection divided by size of union of two sets. One version of a Jaccard Similarity mathematical formula utilized by some embodiments of the present disclosure is:

$$J ( A , B ) = \frac{\vert A ⋂ B \vert}{\vert A ⋃ B \vert} = \frac{\vert A ⋂ B \vert}{\vert A \vert + \vert B \vert - \vert A ⋂ B \vert} .$$

In some embodiments, similarity algorithms based on latent semantic analysis (LSA) may be utilized. In some embodiments, LSA uses a document-term matrix, which describes the occurrences of terms in documents, to analyze relationships between a set of documents and the terms that they contain.

Referring now to FIGS. 3A, 3B, and 3C together, as discussed above, stop word remover 222, relevance finder 224, and similarity finder 226 each utilize a variety of machine learning methods, such as, but not limited to, supervised learning methods 304, along with training data 302 to train a variety of machine learning models to assist in stop word removal, relevance finding, and similarity finding. In various embodiments, machine learning user interfaces, such as stop word training user interface 314 of FIG. 3B, and relevance training user interface 320 of FIG. 3C, enables users to oversee the training of the various machine learning models utilized by the disclosed embodiments.

FIG. 3F is an illustrative example of training data 302 utilized by relevance finder 224 and similarity finder 226, in accordance with one embodiment.

Referring now to FIG. 2A and FIG. 3A together, in one embodiment, user interfaces 206 may include one or more end-user interfaces, such as user interface 206 provided to client support professional 210. In one embodiment, the output of similarity finder 226 is a ranked listing of historic closed cases that were found by document similarity finder 216 to be similar to one or more current open cases being worked by client support professional 210. In one embodiment, RPA workers 212 provide similar cases data 213 to client support professional 210 through user interface 206 of client service system 207. In one embodiment, ranked similar case data 232 is provided to skilled expert finder 228, as will be discussed in additional detail below.

Referring again to FIG. 3A, in one embodiment, document similarity finder 216 also includes rules and constraints layer 306, and master data and security layer 308. As part of the application infrastructure, rules and constraints layer 306, and master data and security layer 308 are provided to allow configuration of the pieces of data to be processed, how the data is to be processed, and which users have access to which portions of the various user interfaces. For example, master data and security layer 308 can provide user management features to allow different users to be associated with different roles, and master data and security layer 308 can also control integration options, for example, how often to perform scheduled jobs. In some embodiments, data may be updated and processed in real-time, while in other embodiments, data processing jobs may be scheduled at specific intervals, such as every hour, every day, etc.

With respect to rules and constraints layer 306, a variety of parameters can be configured, such as but not limited to, those set forth in the following table.

| Rule Parameter | Options | | Comments |
|---|---|---|---|
| Initiate Number of RPA | 7 × N | | Multiple of ten workers |
| Workers | | | Starting with 7 × 1 |
| Initiate Case Assistant | 1. | Document Similarity Finder | Option to select |
| RPA Worker Job Type | 2. | Skilled Expert Finder | multiple Worker Types |
| | 3. | Business Exception Finder | |
| Similarity Finder - Use | 1. | Cosine Similarity | Dynamic selection of |
| Algorithm | 2. | LSA Similarity | algorithm |
| | 3. | Jaccard Similarity | Default Cosine |
| | 4. | Dynamic | Similarity |
| Skills Gap - Team | 1. | Case Owner, Lead Engineer and Case Team | Default #1 |
| Definition | 2. | Lead Engineer and Case Team | |
| | 3. | Case Team | |
| Enable Case Assistant to | 1. | Product Line 1 | Option to select |
| Product Lines | 2. | Other Product Lines | multiple Worker Types |

As shown in the above table, rules and constraints layer 306 allows the number of RPA workers utilized by the case assistant to be easily scaled, depending on a variety of case factors. For example, a designation of 7×1 RPA workers indicates that there are 7 different jobs to perform, and 1 RPA worker will be initiated for each job. If more RPA workers are desired, this can be upped to 7×10 (ten workers for each of the 7 jobs), 7×100 (100 workers for each of the 7 jobs), or any number of workers for any number of jobs desired by a user of the case assistant system. In one embodiment, overall service provider case volume is used to spawn a number of case workers to assign to each job for each case, to ensure that the service provider has enough computer power to handle all of the jobs for all of the cases.

In one embodiment, rules and constraints layer 306 allows one or more RPA worker job types to be enabled and/or disabled. For example, in one embodiment, RPA workers may be configured to perform all of document similarity finding, skilled expert finding, and business exception finding. In one embodiment RPA workers may be configured to perform only document similarity finding. While only three job types are listed here for example, any number and type of jobs can be configured to be performed by RPA workers.

In one embodiment, rules and constraints layer 306 allows for selection of the similarity finding process/algorithm to be used by similarity finder 226 of document similarity finder 216. As noted above, in various embodiments, a similarity process/algorithm is selected from the following processes/algorithms: Cosine Similarity algorithm; Jaccard Similarity algorithm; and LSA Similarity algorithm and/or any other process/algorithm as known in the art at the time of filing and/or as developed or made available after the time of filing. In one embodiment, a user can also configure dynamic selection of the similarity process/algorithm. In one embodiment, Cosine Similarity process/algorithm is the default process/algorithm used.

In one embodiment, rules and constraints layer 306 allows for teams to be defined for use by the skilled expert finder, which will be discussed in additional detail below. In one embodiment, by default, a team is defined as including Case Owner, Lead Engineer and Case Team. In one embodiment, rules and constraints layer 306 allows for enabling and/or disabling case assistant jobs for specific product lines.

Returning now to FIG. 2A, when document similarity finder 216 identifies historical closed cases similar to one or more current open cases being worked by client support professional 210, the details of the resolution of the similar historic closed cases are extremely valuable in finding a resolution to current open cases represented by current open case data 246. RPA workers 212 of case assistant system 102 are able to provide data and advice to client support professional 210 in the form of potential functional solutions to case resolution, which can often be extremely useful for the client support professional 210 who may be working on one or more open cases represented by current open case data 246.

Further, when similar cases data 213 is presented to client support professional 210, case assistant system 102 enables client support professional 210 to provide feedback on whether the similar cases data 213 provided by one or more of the RPA workers 212 was helpful in resolution of the case, and in turn, this similar cases feedback data (not shown) can then be used to further refine training data for the ML models and processes/algorithms utilized by RPA workers 212.

Consequently, case document similarity finding processes, such as those provided by document similarity finder 216, can be utilized by RPA workers 212 using various machine learning processes/algorithms. Furthermore, the RPA workers 212 associated with document similarity finder 216 can be built, trained, configured, and associated with a variety of continuous processes running in the background of a client service system, such as client service system 207. Additionally, the RPA workers 212 processes associated with document similarity finder 216 of case assistant system 102 are continuous processes which are able to continuously, in near real-time, look for assistance that can be provided to client support professional 210. Consequently, utilization of RPA workers 212 allows case assistant system 102 to proactively assist client support professionals with resolution of the current open cases represented by current open case data 246. In one embodiment, by utilizing the case assistant system 102 in combination with RPA workers 212, the speed, efficiency and accuracy of client support professional 210 work is increased, thereby allowing client support professional 210 to more rapidly and successfully resolve client cases.

As discussed above, in various embodiments, aspects of case assistant system 102 can be configured to work within defined boundaries/rules and constraints, which may be accessed from rules and constraints database 260, and taken into account during each of the process operations described herein. While details of the rules and constraints database 260, including similarity algorithm data 262, product line data 264, support team data 266, and RPA data 268 were discussed above in relation to rule and constraints layer 306 of document similarity finder 216, data from rules and constraints database 260 may also be utilized by other aspects of case assistant system 102, such as skilled expert finder 228, which will be discussed in additional detail below.

In one embodiment, skilled expert finder 228 of case assistant system 102 is utilized by one or more RPA workers 212 to alert support professionals, such as client support professional 210, on the existence of skilled experts (e.g., employees of the service provider) who have previously resolved cases similar to one or more of the current open cases being worked by client support professional 210. Upon identification of skilled experts, and generation of experts data 214, skilled expert finder 228 can also function to initiate collaboration between client support professional 210 and one or more skilled experts represented by experts data 214. For example, when cases are resolved, they can be associated with experts who have worked to resolve the cases. Thus, when document similarity finder 216 identifies historic closed cases that are similar to one or more of the current open cases, skilled expert finder 228 can be utilized by RPA workers 212 to identify the associated experts who have resolved the issues in the past. Additionally, skilled expert finder 228 can utilize skills manager 110 of case assignment advisor 106 to identify the experts whose skills are the most relevant to resolving the current open cases. The RPA workers can then provide ranked skilled experts data to initiate and offer case review by the identified skilled experts. Comments from the identified skilled experts can then be saved in the case itself as internal comments, which helps to improve collaboration opportunities between one or more experts and client support professional 210, thus accelerating and enhancing case resolution.

A detailed description of embodiments of case assignment advisor 106 can be found in a related application to Sahni et al., entitled “METHOD AND SYSTEM FOR PROVIDING A MULTI-DIMENSIONAL HUMAN RESOURCE ALLOCATION ADVISER” U.S. patent application Ser. No. 16/195,668, filed Nov. 19, 2018, which issued as U.S. Pat. No. 11,182,707 on Nov. 23, 2021, which is hereby incorporated by reference in its entirety as if it were fully set forth herein.

The case assignment advisor described in U.S. Pat. No. 11,182,707 details systems and methods for recommending skilled experts that are available to work open cases through use of a variety of machine learning techniques based on factors such as, but not limited to, open case skills requirements, initial employee skill set data, dynamic employee skill set data, employee workload data, and employee availability data.

In one embodiment, skilled expert finder 228 of case assistant system 102 utilizes the portion of features of case assignment advisor 106 specifically related to skills analysis and management, which is represented in FIG. 2A by autonomous machine learning platform 252 and skills manager 110 of case assignment advisor 106.

FIG. 2B is a block diagram of a production environment 200B associated with case assignment advisor 106 utilized by case assistant system 102, in accordance with one embodiment.

In one embodiment, production environment 200B includes case assistant system 102 and service provider computing environment 205. In one embodiment, service provider computing environment 205 includes processor 203, physical memory 204, and case assignment advisor 106. In one embodiment, case assignment advisor 106 includes autonomous machine learning platform 252 and case intake and management system 240.

In one embodiment autonomous machine learning platform 252 includes enterprise machine learning (ML) database 270, skills manager 110, ML engine 280, and ranked skill matched employee data 230. In one embodiment, enterprise ML database 270 includes aggregated employee skill set data 272, current open case skill set vector data 274, initial skill set matched employee data 276, and normalized employee skill set vector data 278. In one embodiment, skills manager 110 includes employer business database 256, which further includes employee HR data 255, initial employee skill set data 257, and dynamic employee skill set data 259. In one embodiment, ML engine 280 includes pre-processing module 282 and skill matching, normalization, and ranking module 284. In one embodiment, case intake and management system 240 includes case intake and management database 242, which further includes client data 244, current open case data 246, and historical closed case data 248.

In various embodiments, case assistant system 102 uses all, or part, of the components and functions of case assignment advisor 106 and autonomous machine learning platform 252, with various modifications, to perform its assigned tasks and provide its respective functions to users. One focus of the current disclosure is on the interaction of case assignment advisor 106 and autonomous machine learning platform 252 with case assistant system 102 for the purpose of providing ranked skill matched employee data 230 to case assistant system 102, for use in identifying skilled experts to assist client support professionals with resolving current open cases.

To this end, as seen in FIG. 2B, in one embodiment, autonomous machine learning platform 252 includes enterprise ML database 270 and ML engine 280. As discussed in more detail below, in the operation of one embodiment, enterprise ML database 270 is the main repository for data obtained from, and/or provided/generated by, the other components of case assignment advisor 106. As such, in one embodiment, enterprise ML database 270 receives data from the other components, and provides data to the other components, of case assignment advisor 106 and is therefore, in one embodiment, the central hub of case assignment advisor 106.

In one embodiment, case intake and management system 240 represents one or more computing systems and databases through which sales personnel for a service provider take in and record sales, track contracts and performance for both historic and current tasks, projects, or cases, coordinate new incoming tasks, projects, or cases, track on-going performance and milestones, record client feedback and satisfaction, and perform any other client intake and customer relations management functions as discussed or illustrated herein, and/or as known in the art at the time of filing, and/or as made known/available after the time of filing.

As seen in FIG. 2B, in one embodiment, case intake and management system 240 includes case intake and management database 242. In one embodiment, case intake and management database 242 includes historical closed case data 248. In one embodiment, historical closed case data 248 is aggregated data and includes case history data such as, but not limited to, closed case subject, closed case description, closed case abstract, product name associated with closed case, product line associated with closed case, modules, skills and experience associated with the closed case, closed case root cause, closed case solution, client support professionals responsible for resolving the closed cases, closed case communications and comments data, closed case resolution time, client associated with closed case, closed case client satisfaction review data, closed case client relations management data, and/or any other historical case data as discussed or illustrated herein, and/or as known in the art at the time of filing, and/or as made known/available after the time of filing.

In one embodiment, case intake and management database 242 further includes current open case data 246. In one embodiment, current open case data 246 includes, but is not limited to, data representing: the name of the task, project, or case; the name of the client for which the task, project, or case is to be performed; the name of one or more client support professionals assigned to the task, the priority of the task, project, or case; the priority of the client associated with the task, project, or case; the job equipment type or product line associated with the task, project, or case; any subcomponents included with the job equipment type or product line associated with the task, project, or case; the type of task, project, or case; the complexity of the task, project, or case; whether the client associated with the task, project, or case is an escalated or strategic client; the average of any survey or review data associated with the client and/or task, project, or case; the geographic location of the client and/or where the task, project, or case is to be performed; the time zone associated with the location of the client and/or where the task, project, or case is to be performed; and/or any other current open case data as discussed or illustrated herein, and/or as known in the art at the time of filing, and/or as made available after the time of filing.

In one embodiment, case intake and management database 242 further includes client data 244. In one embodiment, client data 244 is aggregated client data and can include, but is not limited to, data representing: the name of the client; the priority of the client; the type of equipment or product lines associated with the client; any contractual obligations and/or requirements associated with the client and/or task, project, or case performed on behalf of the client; whether the client is an escalated or strategic client; the average of any survey or review data associated with the client; client relationship history; the geographic location of the client; the time zone associated with the location of the client; and/or any other client data as discussed or illustrated herein, and/or as known in the art at the time of filing, and/or as made available or known after the time of filing.

In one embodiment, all, or part of, the data stored in case intake and management database 242, including but not limited to, all, or part of, historical closed case data 248, current open case data 246, and client data 244 is provided to enterprise ML database 270 and stored in enterprise ML database 270 for access and use by the other components of case assignment advisor 106.

As seen in FIG. 2B, in one embodiment, skills manager 110 of autonomous machine learning platform 252 includes employer business database 256. In one embodiment, employer business database 256 includes data associated with the employer business and the employees of the employer business, which in some embodiments include client support professionals.

In one embodiment, employer business database 256 includes employee human resources (HR) data 255. In one embodiment, employee HR data 255 can include, but is not limited to: the geographic location of the employees of the employer business; the time zone associated with the employees of the employer business; the working time zone associated with the employees of the employer business; human languages the employees of the employer business understand, speak or write; machine and programming languages the employees of the employer business have proficiency with; certifications and/or education data associated with the employees of the employer business; employee type, such as full-time, part time, contractor, etc. associated with the employees of the employer business; review and client customer satisfaction data associated with the employees of the employer business; planned Paid Time Off (PTO) associated with the employees of the employer business; and/or any other HR data, as discussed or illustrated herein, and/or as known in the art at the time of filing, and/or as becomes known/available after the time of filing.

In one embodiment, employer business database 256 includes initial employee skill set data 257. In one embodiment, initial employee skill set data 257 can include, but is not limited to: employee skill set/experience data obtained from the employees themselves; employee skill set/experience data obtained from the employees' employment records; employee skill set/experience data obtained from the employees' HR records; employee skill set/experience data obtained from public records of certifications and schooling; employee accounts with professional social media sites; employee skill set/experience data obtained from general social media sites; employee skill set/experience data obtained from previous employers of the employee; and/or any other source of initial, self-reported/declared, and/or relatively static initial employee skill set data, as discussed or illustrated herein, and/or as known in the art at the time of filing, and/or as developed after the time of filing.

In one embodiment, employer business database 256 includes dynamic employee skill set data 259. In one embodiment, dynamic employee skill set data 259 is derived from historical closed case data 248 and the skills and experience obtained/acquired by each employee “on the job.”

In one embodiment, dynamic employee skill set data 259 is obtained at the product line, product, and release or version level, based on one or more of: dynamically updated task, project, or case closure data associated with the employees, including total number of closed tasks, projects, or cases; dynamically updated average time to close for tasks, projects, or cases; dynamically updated average client survey or ranking data per customer/product/employee; dynamically updated experience and team participation data; dynamically updated team leadership experience data; dynamically updated case priority experience; dynamically updated milestones per time period for determining the current loading of the employee; and/or any other source of dynamic employee skill set data as discussed or illustrated herein, as known in the art at the time of filing, and/or as developed after the time of filing.

As seen in FIG. 2B, in one embodiment, autonomous machine learning platform 252 includes ML engine 280. In one embodiment, ML engine 280 performs the pre-processing, skill matching, normalization, and ranking functions for autonomous machine learning platform 252. To this end, in one embodiment, ML engine 280 includes pre-processing module 282, and skill matching, normalization, and ranking module 284. In one embodiment, pre-processing module 282 performs the functions of obtaining, transferring, processing, aggregating, rectifying, storing, and updating various data from multiple data sources for, and into, enterprise ML database 270.

In one embodiment, employee skill set consolidation/aggregation is performed at pre-processing module 282 of ML engine 280 to generate aggregated employee skill set data 272 for each employee of the employer business using all of, or part of, the employee initial employee skill set data 257, the dynamic employee skill set data 259, and the employee HR data 255. In one embodiment, all, or part of, aggregated employee skill set data 272 is then provided to enterprise ML database 270 and stored in enterprise ML database 270 for access and use by the other components of case assignment advisor 106.

In one embodiment, pre-processing module 282 obtains and processes all, or part of, the initial employee skill set data 257, the dynamic employee skill set data 259, and the employee HR data 255 based on a multi-dimensional analysis of the initial employee skill set data 257, dynamic employee skill set data 259, and employee HR data 255 to generate aggregated employee skill set data 272 for each employee of the employer business and dynamically updates the aggregated employee skill set data 272 on a periodic basis, and/or as new data becomes available. In one embodiment, the aggregated employee skill set data 272 is updated in near real-time.

In one embodiment, all, or part of, aggregated employee skill set data 272 is then provided to enterprise ML database 270 by pre-processing module 282 and stored in enterprise ML database 270 for access and use by the other components of case assignment advisor 106, and the aggregated employee skill set data 272 in enterprise ML database 270 is dynamically updated by pre-processing module 282 on a periodic basis, and/or as new data becomes available. In one embodiment, the aggregated employee skill set data 272 is updated in near real-time.

The aggregated employee skill set data 272 provides employee skill set dimensions that bring unique and different perspectives of employee skills that are important for a unified view of the employee skills, and, as discussed in more detail below, allow for the generation and normalization of employee skill set data which, in turn, is used in one embodiment, to generate the disclosed normalized employee skill set vector data 278 used for making conclusions and decisions for providing ranked skill matched employee data 230 to case assistant system 102 in accordance with one embodiment.

In one embodiment, pre-processing module 282 further obtains all, or part of, historical closed case data 248, current open case data 246, and client data 244 including skill set data for skills required for resolution of the current open cases, which in one embodiment is derived from current open case data 246 and client data 244 and represents the skill sets that will be required of employees in order to meet the needs of the tasks, jobs and/or projects associated with the current open cases. In one embodiment, pre-processing module 282 then processes this data to generate current open case skill set vector data 274 representing the identified skill sets associated with the current open cases. In one embodiment, current open case skill set vector data 274 is then provided to enterprise ML database 270 by pre-processing module 282 and stored in enterprise ML database 270 for access and use by the other components of case assignment advisor 106.

As seen in FIG. 2B, in one embodiment, once enterprise ML database 270 has been provided with various pre-processed data, including, but not limited to, aggregated employee skill set data 272, and current open case skill set vector data 274, this data is updated periodically and made available for access and use by the other components of case assignment advisor 106, including skill matching, normalization, and ranking module 284.

In one embodiment, enterprise ML database 270 and skill matching, normalization, and ranking module 284 exchange and update data to generate ranked skill matched employee data 230. In one embodiment, at skill matching, normalization, and ranking module 284, machine learning processes/algorithms are used to identify, normalize, and rank the aggregated employee skill set data 272 with respect to skill sets identified as being needed for a given task, and/or project, as represented by current open case skill set vector data 274.

In one embodiment, the current open case skill set vector data 274 is generated by one or more machine learning services and/or modules of skill matching, normalization, and ranking module 284. In various embodiments, the set of one or more of the machine learning services or modules includes, but is not limited to, one or more of: a supervised machine learning service or model; an unsupervised machine learning service or model; a semi-supervised machine learning service or model; or any other machine learning service or model capable of generating current open case skill set vector data 274 as discussed or illustrated herein, and/or as known in the art at the time of filing, and/or as developed or made available after the time of filing. In one embodiment, once generated by skill matching, normalization, and ranking module 284, current open case skill set vector data 274 is provided to enterprise ML database 270 and stored in enterprise ML database 270 for access and use by the other components of case assignment advisor 106.

In one embodiment, skill matching, normalization, and ranking module 284 generates normalized employee skill set vector data 278. To this end, in one embodiment, the aggregated employee skill set data 272 for each employee and the current open case skill set vector data 274 are skill matched, i.e., processed using skill finding routines, by skill matching, normalization, and ranking module 284 to generate initial skill set matched employee data 276 representing employees that appear to have associated skill set data that matches, or most closely matches, the skill set indicated in the current open case skill set vector data 274 along with the aggregated employee skill set data 272 associated with the initial skill set matched employees represented by initial skill set matched employee data 276.

In one embodiment, the aggregated employee skill set data 272 for each employee and the current open case skill set vector data 274 are skill matched by skill matching, normalization, and ranking module 284 using one or more machine learning processes/algorithms such as, but not limited to, K nearest Neighbor (KNN) classification and weighted or non-weighted Euclidian Distance methods, or any other classification processes/algorithms/methods, as discussed or illustrated herein, and/or as known in the art at the time of filing, and/or as developed after the time of filing.

In one embodiment, employees are initially determined to match, or most closely match, the skill set indicated in the current open case skill set vector data 274 by skill matching, normalization, and ranking module 284 based on identified common skills present in both the current open case skill set vector data 274 and the aggregated employee skill set data 272, also called matched skills or matched skill features.

In one embodiment, skill matching, normalization, and ranking module 284 then uses machine learning processes/algorithms to identify, normalize, and rank aggregated employee skill set data 272 with respect to skill sets identified as being needed for a given task or project. As noted above, in one embodiment, the matched skills included in the skill set data for each initial skill set matched employee are normalized by skill matching, normalization, and ranking module 284 to generate normalized employee skill set vector data 278 for each employee. In one embodiment, the normalization process is based on the aggregated dynamic “on-the-job” acquired skill set data for the employee associated with the matched skills of dynamic employee skill set data 259.

As noted above, in various embodiments, the dynamic employee skill set data 259 of employer business database 256 for the employee associated with the matched skill set features can include, but is not limited to, data representing one or more of: total cases closed by the employee related to the matched skill set feature; the average time to close for cases worked on by the employee related to the matched skill set feature; average customer satisfaction review scores for the employee matched skill set feature; total cases owned and/or closed by the employee that are related to the matched skill set feature; total cases led and closed by the employee that are related to the matched skill set feature; total cases contributed to by the employee that are related to the matched skill set feature; average resolution time associated with total cases owned, and/or closed, and/or participated in by the employee that are related to the matched skill set feature; average reviews and customer satisfaction input/ratings for the employee or team associated with the matched skill set feature; and/or any other dynamic skill set data associated with an employee and a matched skill set feature, as discussed or illustrated herein, and/or as known in the art at the time of filing, and/or as becomes available after the time of filing.

The particulars of the process for skill matching, normalization and ranking performed by skill matching, normalization and ranking module 284 will be discussed in additional detail below.

In one embodiment, once generated by skill matching, normalization, and ranking module 284, the normalized employee skill set vector data 278 for each employee is provided to enterprise ML database 270 and stored in enterprise ML database 270 for access and use by the other components of case assignment advisor 106.

In one embodiment, normalized employee skill set vector data 278 for each initially matched employee is generated by skill matching, normalization, and ranking module 284 using one or more machine learning services and/or models and matched normalized employee skill set data and skill set features as input data. In various embodiments, one or more of the machine learning services or modules includes but is not limited to, one or more of: a supervised machine learning service or model; an unsupervised machine learning service or model; a semi-supervised machine learning service or model; or any other machine learning service or model capable of generating normalized employee skill set vector data 278, as discussed or illustrated herein, and/or as known in the art at the time of filing, and/or as developed or made available after the time of filing.

In one embodiment, once generated by skill matching, normalization, and ranking module 284, the normalized employee skill set vector data 278 for each employee is provided to enterprise ML database 270 and stored in enterprise ML database 270 for access and use by the other components of case assignment advisor 106.

As seen in FIG. 2B, in one embodiment, ranked skill matched employee data 230 is generated by skill matching, normalization, and ranking module 284. In one embodiment, ranked skill matched employee data 230 is generated by skill matching, normalization, and ranking module 284 using current open case skill set vector data 274 and the normalized employee skill set vector data 278 and one or more machine learning processes/algorithms. In one embodiment, skill matching, normalization, and ranking module 284 uses current open case skill set vector data 274 and the normalized employee skill set vector data 278 as input to one or more previously trained machine learning models.

In one embodiment, the previously trained machine learning model is trained in an offline environment (not shown) using total cases closed by the employee, average resolution time for cases closed by the employee, average customer satisfaction review score data for the employee, historic case data, historic client data, historic initial employee skill set data, historic dynamic employee skill set data, historic employee HR data, and historic rules and constraints data, as well as historic task, project, or case completion data, historic customer review/ratings data, and other historic case and employee data as training data. In one embodiment, using this training data, the machine learning model is trained to match and rank the normalized employee skill set vector data 278 for initially matched employees with the current open case skill set vector data 274.

In various embodiments, the machine learning model is any one or more of: a supervised machine learning service or model; an unsupervised machine learning service or model; a semi-supervised machine learning service or model; or any other machine learning service or model capable of being trained to match and rank the normalized employee skill set vector data 278 for initially matched employees with current open case skill set vector data. As a specific illustrative example, in one embodiment, the machine learning model utilizes weighted or non-weighted Euclidian Distance methods, or any other ranking processes/algorithms/methods, as discussed or illustrated herein, and/or as known in the art at the time of filing, and/or as developed after the time of filing.

As seen in FIG. 2B, in one embodiment, the output of the machine learning model, and skill matching, normalization, and ranking module 284, is ranked skill matched employee data 230. In one embodiment, the ranked skill matched employee data 230 includes data representing the employees matched, or most closely matched, to the current open case along with the employee's aggregated employee skill set data 272. In one embodiment, the ranked skill matched employee data 230 for the current open case includes data representing the employee, or employees, having aggregated employee skill set data 272 most closely matching the current open case skill set vector data 274. In one embodiment, ranked skill matched employee data 230 is then provided to case assistant system 102 for further processing.

Returning now to FIG. 2A, in one embodiment, ranked skill matched employee data 230 is provided by case assignment advisor 106 to skilled expert finder 228 of case assistant system 102. In one embodiment, ranked similar case data 232, as previously generated by document similarity finder 216 is also provided to skilled expert finder 228. In one embodiment, skilled expert finder 228 merges the ranked skill matched employee data 230 and the ranked similar case data 232 to generate ranked skilled experts data 234, which in the embodiments disclosed herein represents data associated with the employees of the service provider business that have resolved cases similar to the current open case, and have a skill set that most closely matches the skill set required for effective resolution of the current open case. In one embodiment, ranked skilled experts data 234 is formatted into experts data 214, and RPA workers 212 provide the formatted experts data 214 to client support professional 210 through user interface 206 of client service system 207, which enables client support professional 210 to more rapidly and successfully resolve client cases through collaboration with skilled experts.

As noted above, in one embodiment, ranked similar case data 232 is generated in part by using one or more similarity processes/algorithms, such as, but not limited to, Cosine Similarity algorithm, Jaccard algorithm, and LSA algorithm. In one embodiment, ranked skill matched employee data 230 is generated in part by using one or more processes/algorithms, such as, but not limited to the Euclidean Distance algorithm. In one embodiment, skilled expert finder 228 merges the values generated by each process/algorithm used to arrive at a “closeness” factor, which provides a way to rank the skilled experts represented by the ranked skilled experts data 234.

In some embodiments, skilled expert finder 228 is also utilized to identify skill gaps during case life cycle. Resolving enterprise cases often requires wide and deep product, technology, and industry knowledge, as well as other skills like local language and localization. As the case life cycle progresses, often the skill set required for the case changes, and so it becomes important to periodically re-evaluate the skills of the client support professionals assigned to the case during the case life cycle. For example, during the life cycle of a case, communications typically go back and forth between the client and the client support professionals. As more knowledge about a case is gained, the case gains more direction, and becomes more defined. Often, during these communications, new information is received regarding the cause of the problem. As one simplified example, when a case first begins, the client support professionals assigned to the case may be looking at technologies associated with product component A and product component B, however by the time the professionals obtain more details regarding the case, for instance, in the middle of, or towards the end of the case life cycle, the case professionals may discover that the product skills needed to resolve the case are actually skills associated with component C and D. In one embodiment, the RPA workers 212 associated with skilled expert finder 228 can continuously check in the background to determine whether there are skill gaps and identify additional client support professionals who can be assigned to the case.

It should be noted that for this particular use case of the skilled expert finder 228, additional functionality may need to be provided by case assignment advisor 106 in order to assign new client support professionals to a case. For instance, in the embodiment of FIG. 2B, because case assistant system 102 is looking for experts to advise on cases (as opposed to actively work cases), many rules and constraints, filtering, and load balancing features that can be provided by case assignment advisor 106 are not necessary. In a situation where a new support professional needs to be added to a case, however, these additional features may be required. These additional features are all discussed in detail in the related application to Sahni et al., entitled “METHOD AND SYSTEM FOR PROVIDING A MULTI-DIMENSIONAL HUMAN RESOURCE ALLOCATION ADVISER” U.S. patent application Ser. No. 16/195,668, filed Nov. 19, 2018, which issued as U.S. Pat. No. 11,182,707 on Nov. 23, 2021, and is hereby incorporated by reference in its entirety as if it were fully set forth herein.

As shown in FIG. 2A, in one embodiment, case assistant system 102 also includes business exception finder 238. In one embodiment, business exception finder 238 of case assistant system 102 is utilized by one or more RPA workers 212 to proactively alert client support professionals to business execution exceptions. For instance, monitoring case progress is a crucial part of case management, particularly for high priority cases. Often, situations arise that need rapid attention to ensure that the case continues to make progress. Examples of situations that would raise execution alerts include, but are not limited to, an engineer has taken time off of work, an engineer and/or contractor has left the company, and/or multiple high priority cases have been assigned to a particular engineer. In one embodiment, RPA workers 212 of case assistant system 102 can be readily configured through business alerts configuration 236 to continuously search in the background for these types of business execution exceptions to generate business exception data 237, and raise alerts as needed, which can help tremendously to re-ensure commitment to the clients on managing these types of exceptions and special circumstances in an efficient and productive manner. Additional examples of business execution exception alerts provided by case assistant system 102 will be discussed in additional detail below.

### Process

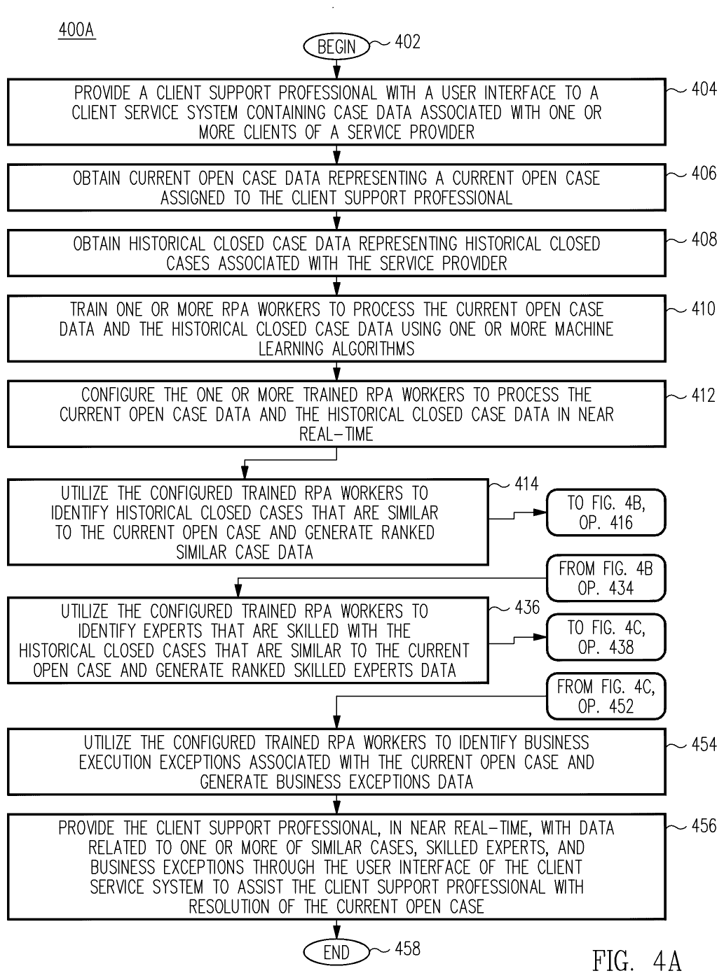

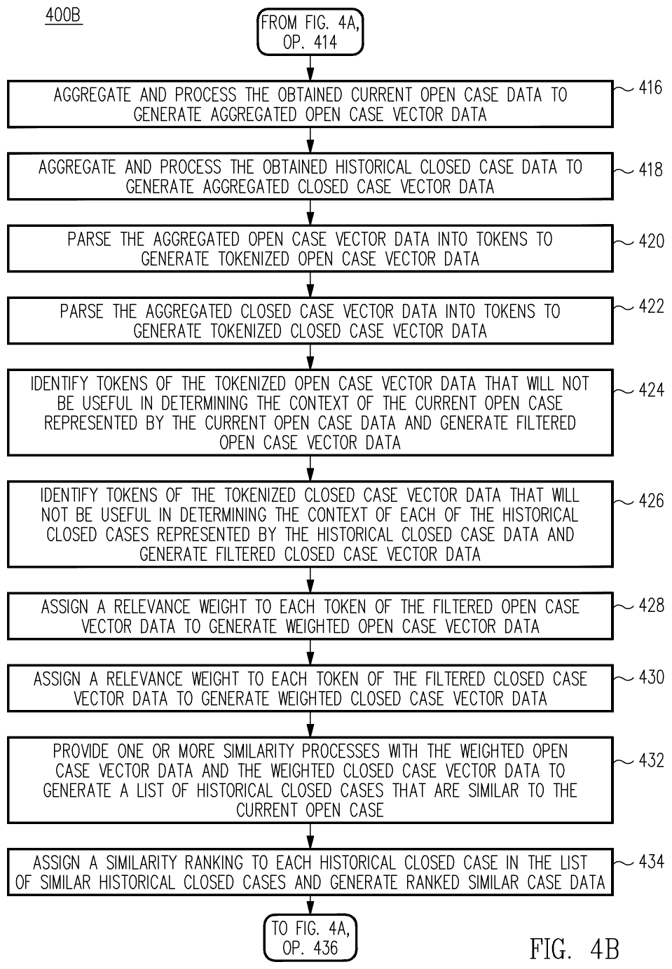

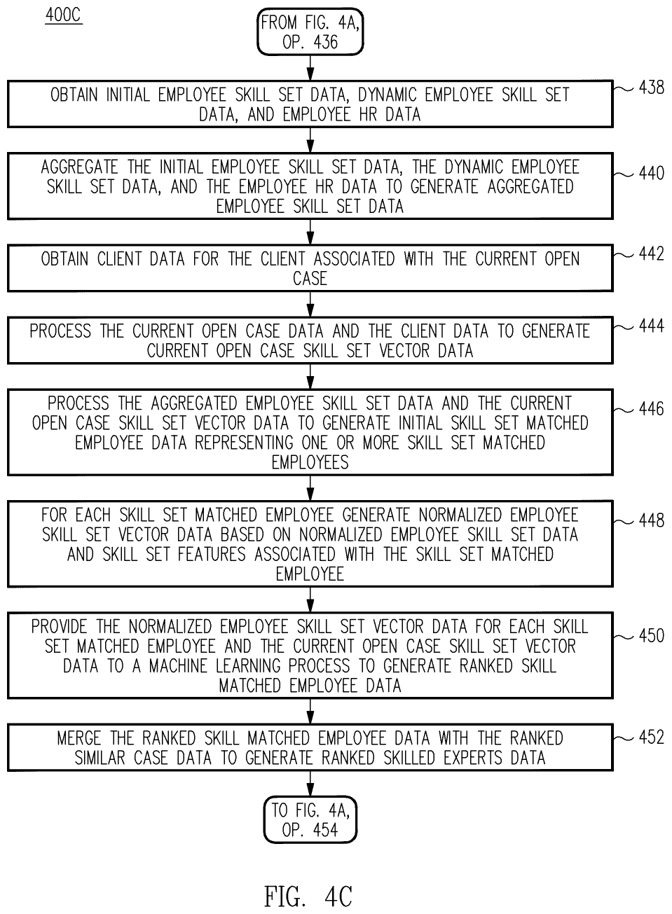

FIG. 4A is a flow chart of a process 400A for providing case assistance to client support professionals, in accordance with one embodiment.

In one embodiment, process 400A begins at BEGIN 402, and process flow proceeds to 404. In one embodiment, at 404, a client support professional is provided with a user interface to a client service system containing case data associated with one or more clients of a service provider.

As noted above, many businesses provide a variety of services to their clients. As such, these businesses may be referred to herein as “service providers.” Further, many businesses utilize one or more computer-based client service systems or client management systems to collect, track, and analyze data about various jobs, tasks, and projects performed by their employees. As such, the term “client service system” as used herein refers to the computer-based systems used by businesses/service providers. Employees of a business/service provider that engage in work that serves to support various needs of their clients, are herein referred to as “client support professionals.” In one embodiment, the user interface to a client service system is provided to the client support professional through one or more computing systems utilized by the client support professional. In the embodiments disclosed herein, the term “computing system” includes any type of computing system capable of providing a client support professional with a user interface that enables them to interact with components of a client service system.

In one embodiment, once a client support professional is provided with a user interface to a client service system at 404, process flow proceeds to 406. In one embodiment, at 406, current open case data is obtained representing a current open case assigned to the client support professional.

As noted above, in one embodiment, current open case data includes, but is not limited to, data representing: the name of the task, project, or case; the name of the client for which the task, project, or case is to be performed; the name of one or more client support professionals assigned to the task, the priority of the task, project, or case; the priority of the client associated with the task, project, or case; the job equipment type or product line associated with the task, project, or case; any subcomponents included with the job equipment type or product line associated with the task, project, or case; the type of task, project, or case; the complexity of the task, project, or case; whether the client associated with the task, project, or case is an escalated or strategic client; the average of any survey or review data associated with the client and/or task, project, or case; the geographic location of the client and/or where the task, project, or case is to be performed; the time zone associated with the location of the client and/or where the task, project, or case is to be performed; and/or any other current open case data as discussed or illustrated herein, and/or as known in the art at the time of filing, and/or as made available after the time of filing.

In one embodiment, once current open case data is obtained at 406, process flow proceeds to 408. In one embodiment, at 408, historical closed case data is obtained representing historical closed cases associated with the service provider.

As noted above, in one embodiment, historical closed case data is aggregated data and includes case history data such as, but not limited to, closed case subject, closed case description, closed case abstract, product name associated with closed case, product line associated with closed case, modules, skills and experience associated with the closed case, closed case root cause, closed case solution, client support professionals responsible for resolving the closed cases, closed case communications and comments data, closed case resolution time, client associated with closed case, closed case client satisfaction review data, closed case client relations management data, and/or any other historical case data as discussed or illustrated herein, and/or as known in the art at the time of filing, and/or as made known/available after the time of filing.

In one embodiment, once historical closed case data is obtained at 408, process flow proceeds to 410. In one embodiment, at 410, one or more RPA workers are trained to process the current open case data and the historical closed case data using one or more machine learning processes.

As discussed above, in various embodiments, the one or more RPA workers are trained using various machine learning processes and techniques to perform data processing jobs including, but not limited to, stop word removal, relevance finding, similarity finding, skilled expert finding, and business exceptions finding. In some embodiments, initial training data is provided to the RPA workers and the training data is continuously updated and refined as the RPA workers perform their assigned data processing jobs. As such, the RPA workers are continuously learning as they perform their functions, which allows them to dynamically adapt to unforeseen conditions and circumstances.

In one embodiment, once one or more RPA workers are trained at 410, process flow proceeds to 412. In one embodiment, at 412 the one or more trained RPA workers are configured to process the current open case data and the historical closed case data in near real-time.

As discussed above, in various embodiments the one or more RPA workers can be configured in a variety of ways. For example, in one embodiment, each RPA worker can be assigned a specific job, such as but not limited to, document similarity finding, skilled expert finding, and business exception finding. Furthermore, each RPA worker can be assigned a particular schedule. For example, some RPA workers can be configured to run continuously in near real-time, while others may be configured to run periodically, such as once every 5 minutes, once an hour, or once a day, or any other scheduled time that is suited to the efficient execution of the job assigned to the RPA worker. In one embodiment, the number of RPA workers assigned to particular jobs can be readily configured and scaled to account for factors such as overall service provider case loads, which results in enhanced performance of the RPA workers.

In one embodiment, once one or more trained RPA workers are configured at 412, process flow proceeds to 414. In one embodiment, at 414, the configured trained RPA workers are utilized to identify historical closed cases that are similar to the current open case, and ranked similar case data is generated.

In one embodiment, identifying historical closed cases that are similar to the current open case and generating ranked similar case data involves a variety of additional process steps, which are set forth in FIG. 4B.

FIG. 4B is a flow chart of a process 400B for identifying similar cases, in accordance with one embodiment.

In one embodiment, in order to identify historical closed cases that are similar to the current open case and generate ranked similar case data at 414 of FIG. 4A, process flow proceeds from 414 of FIG. 4A to 416 of FIG. 4B. In one embodiment, at 416, the obtained current open case data is aggregated and processed to generate aggregated open case vector data.

As discussed in additional detail above, in one embodiment, 416 utilizes a vector data collector, which is the core integration program that collects data from source systems for several defined vectors. In various embodiments, the vector data collector not only collects/aggregates data, but also processes the data to determine which data elements are needed by the various machine learning components that are utilized by a case assistant system of the client service system. In one embodiment, the vector data collector may retrieve current open case data.

In one embodiment, the current open case data is derived from case documents/records that contain unformatted textual data. As such, in one embodiment, the vector data collector processes the current open case data by filtering and formatting the unformatted textual data associated with the current open case data such that the current open case data can be more efficiently utilized by the RPA workers/processes. This data processing results in aggregated open case vector data, which in some embodiments is formatted and filtered to provide the individual RPA workers with the specific data elements that they need in order to properly execute their assigned functions.

In one embodiment, once aggregated open case vector data is generated at 416, process flow proceeds to 418. In one embodiment, at 418, the obtained historical closed case data is aggregated and processed to generate aggregated closed case vector data.

In one embodiment, 418 utilizes the vector data collector to retrieve historical closed case data. In one embodiment, the historical closed case data is derived from case documents/records that contain unformatted textual data. As such, in one embodiment, the vector data collector processes the historical closed case data to filter and format the unformatted textual data associated with the historical closed case data such that the historical closed case data can be more efficiently utilized by the RPA workers/processes. This data processing results in aggregated closed case vector data, which in some embodiments is formatted and filtered to provide the individual RPA workers with the specific data elements that they need in order to properly execute their assigned functions.

In one embodiment, once aggregated closed case vector data is generated at 418, process flow proceeds to 420. In one embodiment, at 420, the aggregated open case vector data is parsed into tokens to generate tokenized open case vector data.

As discussed in more detail above, in one embodiment, 420 utilizes a tokenizer, which parses a document, page, paragraph, or a sentence of aggregated open case vector data into smaller units, such as individual words, groups of words, punctuation marks, numerical values and/or any other types of phrases and/or terms. In one embodiment, while performing the parsing operation, the tokenizer removes many words that potentially do not provide value in terms of defining context of the data. In one embodiment, parsing the aggregated open case vector data results in the generation of tokenized open case vector data.

In one embodiment, once tokenized open case vector data is generated at 420, process flow proceeds to 422. In one embodiment, at 422, the aggregated closed case vector data is parsed into tokens to generate tokenized closed case vector data.

As discussed in more detail above, in one embodiment, 422 utilizes the tokenizer, which parses a document, page, paragraph, or a sentence of the aggregated closed case vector data into smaller units, such as individual words, groups of words, punctuation marks, numerical values and/or any other types of phrases and/or terms. In one embodiment, while performing the parsing operation, the tokenizer removes many words that potentially do not provide value in terms of defining context of the data. In one embodiment, parsing the aggregated closed case vector data results in the generation of tokenized closed case vector data.

In one embodiment, once tokenized closed case vector data is generated at 422, process flow proceeds to 424. In one embodiment, at 424, tokens of the tokenized open case vector data that will not be useful in determining the context of the current open case represented by the current open case data are identified and filtered open case vector data is generated.

As discussed in more detail above, in various embodiments, a stop word remover is utilized, which includes a two-pass process. The two-pass process includes stop word remover pass one, and stop word remover pass two. In one embodiment, stop word remover pass one utilizes standard Natural Language Tool Kit (NLTK) functions to remove stop words from the tokenized open case vector data received from the tokenizer. In one embodiment, stop word remover pass two utilizes supervised machine learning (ML) techniques along with training data to train an ML model with “Ignore List” building. The “Ignore List” functions to remove additional irrelevant or less important tokens from the tokenized open case vector data, which may have been overlooked by stop word remover pass one. In one embodiment, stop word remover pass two also includes a “Qualifier List,” which does the opposite of the “Ignore List” and adds business context words that may have been erroneously ignored in the first automated pass. In various embodiments, the stop word remover further includes a stop word training user interface, which allows users to supervise the training process. In one embodiment, utilizing the stop word remover to process the tokenized open case vector data results in the generation of filtered open case vector data.

In one embodiment, once filtered open case vector data is generated at 424, process flow proceeds to 426. In one embodiment, at 426, tokens of the tokenized closed case vector data that will not be useful in determining the context of each of the historical closed cases represented by the historical closed case data are identified and filtered closed case vector data is generated.

As discussed in more detail above, in various embodiments, the stop word remover is utilized, which includes a two-pass process. In one embodiment, stop word remover pass one utilizes standard Natural Language Tool Kit (NLTK) functions to remove stop words from the tokenized closed case vector data received from the tokenizer. In one embodiment, stop word remover pass two utilizes supervised machine learning (ML) techniques along with training data to train an ML model with “Ignore List” building. The “Ignore List” functions to remove additional irrelevant or less important tokens from the tokenized closed case vector data, which may have been overlooked by stop word remover pass one. In one embodiment, stop word remover pass two also includes a “Qualifier List,” which does the opposite of the “Ignore List” and adds business context words that may have been erroneously ignored in the first automated pass. In various embodiments, the stop word remover further includes a stop word training user interface, which allows users to supervise the training process. In one embodiment, utilizing the stop word remover to process the tokenized closed case vector data results in the generation of filtered closed case vector data.

In one embodiment, once filtered closed case vector data is generated at 426, process flow proceeds to 428. In one embodiment, at 428, a relevance weight is assigned to each token of the filtered open case vector data to generate weighted open case vector data.

As discussed in more detail above, in various embodiments, a relevance finder is utilized by 428, which also includes a two-pass process. In one embodiment, the two-pass process utilized by the relevance finder includes relevance finder pass one, and relevance finder pass two. This two-pass process assigns a relevance weight, which in some embodiments, is number between 0-1, to each contextual token of the filtered open case vector data identified by the stop word remover, based on how relevant the token is in the document.

In one embodiment, relevance finder pass one uses term frequency-inverse document frequency (TF-IDF) to identify the initial weight of the tokens of the filtered open case vector data. Relevance finder pass one then generates a token weight list, and passes the token weight list to relevance finder pass two.

In one embodiment, relevance finder pass two passes the token weight list generated by relevance finder pass one to a “Business Context Enrichment” process for further refining the weight of the tokens of the filtered open case vector data. In one embodiment, supervised learning methods and training data are utilized to enrich the business context list. In one embodiment, a relevance training user interface is provided which allows users to feed (or tag) business words as and when they are encountered and not present in the existing business context list. In one embodiment, utilizing the relevance finder to process the filtered open case vector data results in the generation of weighted open case vector data.

In one embodiment, once weighted open case vector data is generated at 428, process flow proceeds to 430. In one embodiment, at 430, a relevance weight is assigned to each token of the filtered closed case vector data to generate weighted closed case vector data.

As discussed in more detail above, in various embodiments, the relevance finder is utilized by 430, which includes a two-pass process. This two-pass process assigns a relevance weight, which in some embodiments, is number between 0-1, to each contextual token of the filtered closed case vector data identified by the stop word remover, based on how relevant the token is in the document.

In one embodiment, relevance finder pass one uses term frequency-inverse document frequency (TF-IDF) to identify the initial weight of the tokens of the filtered closed case vector data. Relevance finder pass one then generates a token weight list, and passes the token weight list to relevance finder pass two.

In one embodiment, relevance finder pass two passes the token weight list generated by relevance finder pass one to a “Business Context Enrichment” process for further refining the weight of the tokens of the filtered closed case vector data. In one embodiment, supervised learning methods and training data are utilized to enrich the business context list. In one embodiment, a relevance training user interface is provided which allows users to feed (or tag) business words as and when they are encountered and not present in the existing business context list. In one embodiment, utilizing the relevance finder to process the filtered closed case vector data results in the generation of weighted closed case vector data.

In one embodiment, once weighted closed case vector data is generated at 430, process flow proceeds to 432. In one embodiment, at 432, one or more similarity processes are provided with the weighted open case vector data and the weighted closed case vector data to generate a list of historical closed cases that are similar to the current open case.

As discussed in more detail above, in one embodiment, a similarity finder is utilized by 432, which utilizes one or more similarity processes to transform the weighted open case vector data and the weighted closed case vector data into a ranked listing of historical closed cases that are similar to open cases being worked by client support professionals. In one embodiment, the similarity finder ranks the historical closed cases from highest to lowest in similarity, where a ranking of 1=100% similarity, and a ranking of 0=0% similarity. In one embodiment, a similarity threshold value is set to determine a similarity value needed for the document similarity finder to suggest a similar case to a client support professional. In one embodiment, the similarity processes used at 432 may be configured through a rules and constraints configuration interface of the case assistant system.

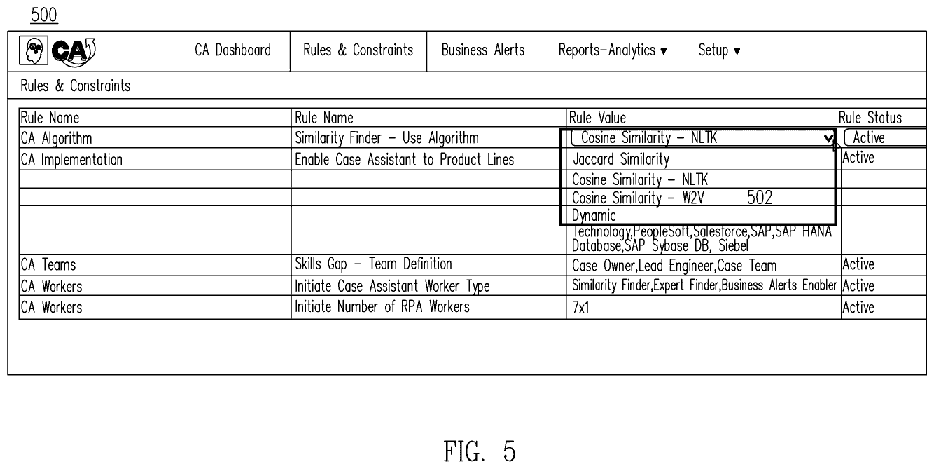

FIG. 5 is an example screenshot of a rules and constraints configuration interface 500 which may be utilized by a case assistant system, in accordance with one embodiment.

As noted above, in one embodiment, the design of a document similarity finder is largely based on dynamic selection of a similarity processes. While a similarity process can be manually selected, through an interface such as rules and constraints configuration interface 500, a document similarity finder is also able to be configured to dynamically select the best similarity process to use based on factors such as, but not limited to, the context of the case problem, the number of documents being compared, the size of each document, the number of pages in each document, the number of paragraphs in each document, the number of words in each document, the file type of each document, as well as the number of relevant words that were found for each document.

For example, one type of similarity process may work best for large documents, while a different similarity process may work best for small documents. Alternatively, or additionally, one similarity process might give better results when the number of relevant words found is high, while a different similarity process might give better results when the number of relevant words found is low. In various embodiments, the ML models utilized by a document similarity finder of a case assistant system can be configured to select the similarity process from the following options dynamically: Cosine Similarity algorithm; Jaccard Similarity algorithm; and LSA Similarity algorithm, as shown in similarity algorithm selection menu 502 of rules and constraints configuration interface 500. In various other embodiments, other processes/algorithms, as discussed herein, and/or as known in the art at the time of filing, and/or as developed or made known after the time of filing can be utilized determine similarity between case documents.

Referring back to FIG. 4B, in one embodiment, utilizing the similarity finder to process the weighted open case vector data and the weighted closed case vector data results in the generation of a list of historical closed cases that are similar to the current open case.

In one embodiment, once a list of historical closed cases that are similar to the current open case is generated at 432, process flow proceeds to 434. In one embodiment, at 434, each historical closed case in the list of similar historical closed cases is assigned a similarity ranking and ranked similar case data is generated.

In one embodiment, once ranked similar case data is generated, process flow proceeds back to FIG. 4A, and operation 436. In one embodiment, at 436, the configured trained RPA workers are utilized to identify experts that are skilled with the historical closed cases that are similar to the current open case and ranked skilled experts data is generated.

In one embodiment, identifying experts that are skilled with the historical closed cases that are similar to the current open case and generating ranked skilled experts data involves a variety of additional process steps, which are set forth in FIG. 4C.

FIG. 4C is a flow chart of a process 400C for identifying skilled experts, in accordance with one embodiment.

In one embodiment, in order to identify experts that are skilled with the historical closed cases that are similar to the current open case and generate ranked skilled experts data at 436 of FIG. 4A, process flow proceeds to 438 of FIG. 4C. In one embodiment, at 438, initial employee skill set data, dynamic employee skill set data, and employee HR data is obtained.

In one embodiment, at 438, the initial employee skill set data is obtained from one or more sources including, but not limited to, one or more of: the employees themselves, and/or the employees' employment records, and/or the employees' HR records, and/or public records of certifications and schooling, and/or employee accounts with professional social media sites, and/or general social media sites, and/or any other source of initial, self-reported/declared, and/or relatively static initial employee skill set data, as discussed or illustrated herein, and/or as known in the art at the time of filing, and/or as developed after the time of filing.

In one embodiment, at 438, dynamic employee skill set data associated with aggregated “on the job” acquired employee skills and performance is obtained.

In one embodiment, the employees' dynamic employee skill set data associated with aggregated “on the job” acquired skills and performance includes, and is obtained at the product line, product, and release or version level based on, one or more of: dynamically updated task, project, or case closure data associated with the employees, including total number of closed tasks, projects, or cases; dynamically updated average time to close for tasks, projects, or cases; dynamically updated average client survey or ranking data per customer/product/employee; dynamically updated experience and team participation data, dynamically updated team leadership experience data; dynamically updated case priority experience; dynamically updated milestones per time period for determining the current loading of the employee; and/or any other source of dynamic employee skill set data as discussed or illustrated herein, as known in the art at the time of filing, and/or as developed after the time of filing.

In one embodiment, at 438, Human Resources (HR) data associated with the employees is obtained. In various embodiments, the HR data associated with the employees can include, but is not limited to: the geographic location of the employee; the time zone associated with the employee; the working time zone associated with the employee; human languages the employee understands, speaks or writes; machine and programming languages the employee has proficiency with; employee certifications and/or education data; employee type, such as full-time, part time, contractor, etc.; employee planned Paid Time Off (PTO); and/or any other HR data, as discussed or illustrated herein, and/or as known in the art at the time of filing, and/or as becomes known/available after the time of filing.

In one embodiment, once initial employee skill set data, dynamic employee skill set data, and employee HR data is obtained at 438, process flow proceeds to 440. In one embodiment, at 440, the initial employee skill set data, the dynamic employee skill set data, and the employee HR data is aggregated to generate aggregated employee skill set data.

In one embodiment, at 440, employee skill set consolidation is performed based on a multi-dimensional analysis of the aggregated initial employee skill set data, dynamic employee skill set data, and other employee data such as, but not limited to, Human Resources (HR), and/or other employee records data, to generate aggregated employee skill set data for each employee, and dynamically update the aggregated employee skill set data for each employee.

As discussed above, in one embodiment, the disclosed consolidating, rectifying, and unifying of the initial employee skill set data, the dynamic employee skill set data, and the employee HR data performed at 440 provides employee skill set dimensions that bring unique and different perspectives of employee skills that are important for a unified view of the employee skills, and, as also discussed in more detail above, allow for the generation and normalization of employee skill set data which, in turn, is used in one embodiment, to generate the disclosed normalized employee skill set vector data used for making conclusions and decisions for case assignments in accordance with one embodiment.

In one embodiment, once aggregated employee skill set data is generated at 440, process flow proceeds to 442. In one embodiment, at 442, client data for the client associated with the current open case is obtained.

In various embodiments, the client data obtained at 442 is aggregated client data and at least part of the client data is obtained as part of current open case data and can include, but is not limited to, data representing: the name of the client; the priority of the client; the type of equipment or product lines associated with the client; any contractual obligations and/or requirements associated with the client and/or task, project, or case performed on behalf of the client; whether the client is an escalated or strategic client; the average of any survey or review data associated with the client; the geographic location of the client; the time zone associated with the location of the client; and/or any other client data, as discussed or illustrated herein, and/or as known in the art at the time of filing, and/or as made available or known after the time of filing.

In various embodiments, the client data is obtained from one or more of, but not limited to: client and/or case records maintained by the employer business; social media accounts associated with the client; websites and advertising associated with the client; and/or any other source of client data, as discussed or illustrated herein, and/or as known in the art at the time of filing, and/or as made available or known after the time of filing.

In one embodiment, once client data for the client associated with the current open case is obtained at 442, process flow proceeds to 444. In one embodiment, at 444, the current open case data and the client data are processed to generate current open case skill set vector data.

In one embodiment, at 442 the current open case data and the client data obtained is processed to identify new case requirements and/or contractual obligations associated with the current open case as well as the skill set that is required of the employees assigned to the current open case in order to meet the needs of the task, project, or case and/or client.

In one embodiment, current open case skill set data is then generated representing the identified new case requirements associated with the current open case and skill set required by the current open case. In one embodiment, current open case skill set data is then vectorized to generate current open case skill set vector data.

In one embodiment, once current open case skill set vector data is generated at 444, process flow proceeds to 446. In one embodiment, at 446, the aggregated employee skill set data and the current open case skill set vector data is processed to generate initial skill set matched employee data representing one or more skill set matched employees.

In one embodiment, at 446, initial skill set matched employee data is generated. In one embodiment, at 446, the aggregated employee skill set data for each employee and the current open case skill set data is skill matched to identify initial skill set matched employee data representing employees that appear to have associated skill set data that matches, or most closely matches, the skill set indicated in the new case skill set vector data, along with their associated skill set data.

In one embodiment, at 446, the aggregated employee skill set data for each employee and the current open case skill set data are skill matched using one or more machine learning processes such as, but not limited to, K nearest Neighbor (KNN) classification and weighted or non-weighted Euclidian Distance methods, or any other classification processes/methods, as discussed or illustrated herein, and/or as known in the art at the time of filing, and/or as developed after the time of filing.

In one embodiment, at 446, employees are initially determined to match, or most closely match, the skill set indicated in the current open case skill set data based on identified common skills present in both the open case skill set data and the aggregated employee skill set data, which in some embodiments, are also called matched skills or matched skill features.

In one embodiment, once initial skill set matched employee data is generated at 446, process flow proceeds to 448. In one embodiment at 448, for each skill set matched employee, normalized employee skill set vector data is generated based on normalized employee skill set data and skill set features associated with the skill set matched employee.

In one embodiment, machine learning processes are used to identify, normalize, and rank the aggregated employee skill set data with respect to skill sets identified as being needed for a given task, project, or case and job specific requirements associated with the given task, project, or case.

In one embodiment, at 448, normalized employee skill set data is generated for each skill set matched employee. In one embodiment, the matched skills included in the skill set for each employee represented in the initial skill set matched employee data are normalized to generate normalized employee skill set data for each employee. In one embodiment, the normalization process is based on the dynamic “on-the-job” acquired skill set data for the employee associated with the matched skills.

In various embodiments, the dynamic skill set data for the employee associated with the matched skill set features can include, but is not limited to, data representing one or more of: total cases closed by the employee; average resolution time for cases closed by the employee; average customer satisfaction review score data for the employee; cases owned and/or closed by the employee that are related to the matched skill set feature; cases led and closed by the employee that are related to the skill set feature; cases contributed to by the employee that are related to the matched skill set feature; resolution time associated with cases owned, and/or closed, and/or participated in by the employee team that are related to the matched skill set feature; reviews and customer satisfaction input/ratings for the employee team associated with the matched skill set feature; and/or any other dynamic skill set data associated with an employee and a matched skill set feature, as discussed or illustrated herein, and/or as known in the art at the time of filing, and/or as becomes available after the time of filing.

In one embodiment, the normalized initial skill set matched employee data for each employee is generated using the dynamic skill set data for the employee associated with the matched skills and one or more machine learning processes such as, but not limited to, Min-Max Normalization, or any other normalization processes/methods, as discussed or illustrated herein, and/or as known in the art at the time of filing, and/or as developed after the time of filing.

The disclosed embodiments provide for “normalizing” the skills of one employee with respect to the skills of another employee so that the skill sets of multiple employees can be compared objectively with respect to the needs of a given task, project, or case. This is accomplished by taking into consideration, and integrating, the effect of historical and current aggregated “on the job” employee performance and dynamic work experience parameters of the employees with respect to their reported/known skills and the potential tasks, projects, or cases and/or clients. As a result, using the disclosed embodiments, the comparisons and analysis of the skill set data of multiple employees reflects “real world” and aggregated “on the job” performance considerations regarding the reported/known skills of the employees and the identified needs of a given task, project, or case or client. Consequently, the disclosed normalization process integrates dynamic employee skills obtained “on the job” to uniformly evaluate an employee's skill set data.

In one embodiment, once normalized employee skill set vector data is generated at 448, process flow proceeds to 450. In one embodiment, at 450, the normalized employee skill set vector data for each skill set matched employee and the current open case skill set vector data is provided to a machine learning process to generate ranked skill matched employee recommendation data.

In one embodiment, at 450, ranked skill matched employee recommendation data is generated using one or more machine learning processes. In one embodiment, at 450, the current open case vector data and the normalized employee skill set vector data for each initially matched employee are used as input data to a previously trained machine learning model.

In one embodiment, the machine learning model is trained in an offline environment using training data including, but not limited to: total cases closed by the employee; average resolution time for cases closed by the employee; average customer satisfaction review score data for the employee; historic case data, historic client data, historic initial employee skill set data, historic dynamic employee skill set data, historic employee HR data, and historic rules and constraints data, as well as aggregated task, project, or case completion data, customer review/ratings data, and other historic case and historic employee data. In one embodiment, using this training data, the machine learning model is trained to match and rank the normalized employee skill set vector data for each initially matched employee with the current open case skill set vector data.

In various embodiments, the machine learning model is any one or more of: a supervised machine learning service or model; an unsupervised machine learning service or model; a semi-supervised machine learning service or model; or any other machine learning service or model capable of matching and ranking the normalized employee skill set vector data for each initially matched employee with the current open case skill set vector data.

As a specific illustrative example, in one embodiment, the machine learning model utilizes weighted or non-weighted Euclidian Distance methods, or any other ranking processes/methods, as discussed or illustrated herein, and/or as known in the art at the time of filing, and/or as developed after the time of filing.

In one embodiment, the output of the machine learning model is ranked skill matched employee recommendation data. In one embodiment, the ranked skill matched employee recommendation data includes data representing the employees matched, or most closely matched, to the current open case.

In one embodiment, once ranked skill matched employee recommendation data is generated at 450, process flow proceeds to 452. In one embodiment, at 452, the ranked skill matched employee data is merged with the ranked similar case data to generate ranked skilled experts data.

As noted above, in one embodiment, ranked similar case data is generated in part by using one or more similarity processes, such as, but not limited to, Cosine Similarity algorithm, Jaccard algorithm, and LSA algorithm. In one embodiment, ranked skill matched employee data is generated in part by using one or more processes, such as, but not limited to the Euclidean Distance algorithm. In one embodiment, at 452, the values generated by each process are merged to arrive at a “closeness” factor, which in one embodiment, provides a way to rank the skilled experts represented by the ranked skilled experts data, thus resulting in the generation of ranked skilled experts data.

In one embodiment, once ranked skilled experts data is generated at 452, process flow proceeds back to FIG. 4A, and operation 454. In one embodiment, at 454, the configured trained RPA workers are utilized to identify business execution exceptions associated with the current open case.

As discussed in more detail above, in one embodiment, a case assistant system utilized by a client service system also includes a business exception finder. In one embodiment, the business exception finder is utilized by one or more RPA workers to proactively alert client support professionals to business execution exceptions. Examples of situations that would raise execution alerts include, but are not limited to, an engineer has taken time off of work, an engineer and/or contractor has left the company, and/or multiple high priority cases have been assigned to a particular engineer.

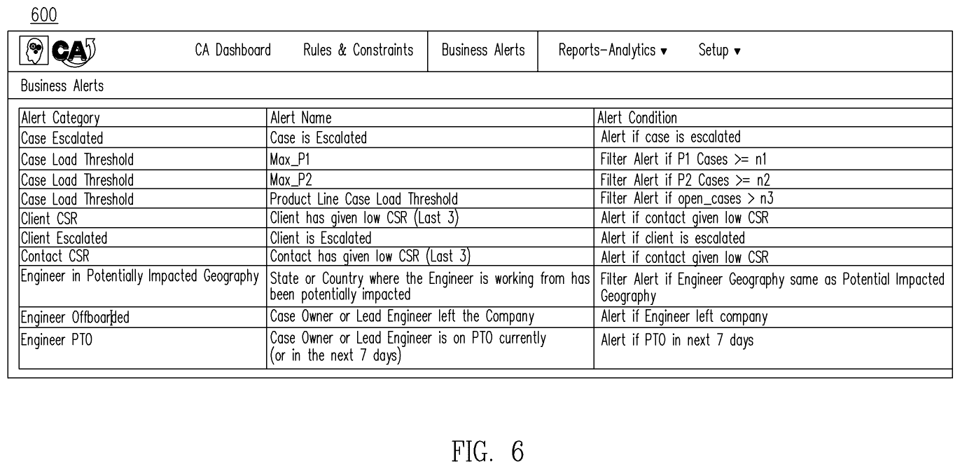

FIG. 6 is a screenshot of a business alerts configuration interface 600 of a business exception finder utilized by a case assistant system, in accordance with one embodiment.

As shown in FIG. 6, a variety of business execution exceptions alerts can be created and configured to provide the client support professional with a wide array of information pertinent to case resolution. For example, in various embodiments, alerts can be generated by the configured RPA workers in situations such as, but not limited to, when a case and/or client is escalated, when one more case load thresholds are exceeded, when changes occur in the service provider's relationship with a client, when a client support professional assigned to a case has left the company, is on leave, and/or is in a region, state or county potentially impacted by events such as storms, floods, earthquakes, tornados, virus outbreaks, active shooters, and the like.

In one embodiment, once business execution exceptions are identified at 454, process flow proceeds to 456. In one embodiment, at 456, the client support professional is provided, in near real-time, with data related to one or more of similar cases, skilled experts, and business exceptions through the user interface of the client service system to assist the client support professional with resolution of the current open case.

Examples of data related to similar cases, skilled experts, and business exceptions being provided to a client support professional through a user interface of the client service system are provided below.

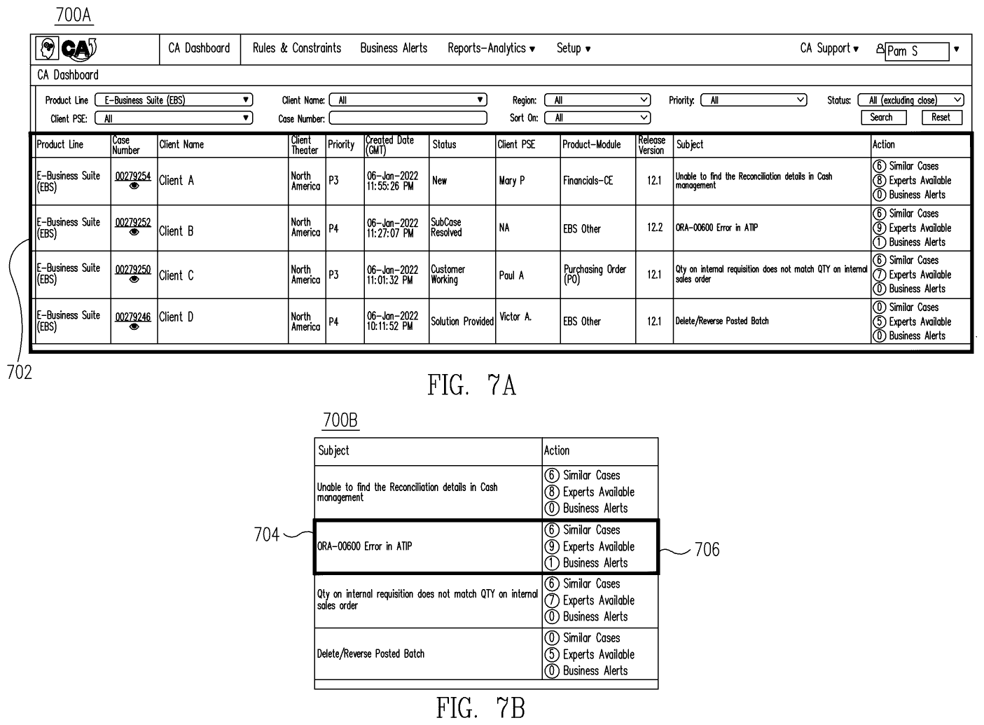

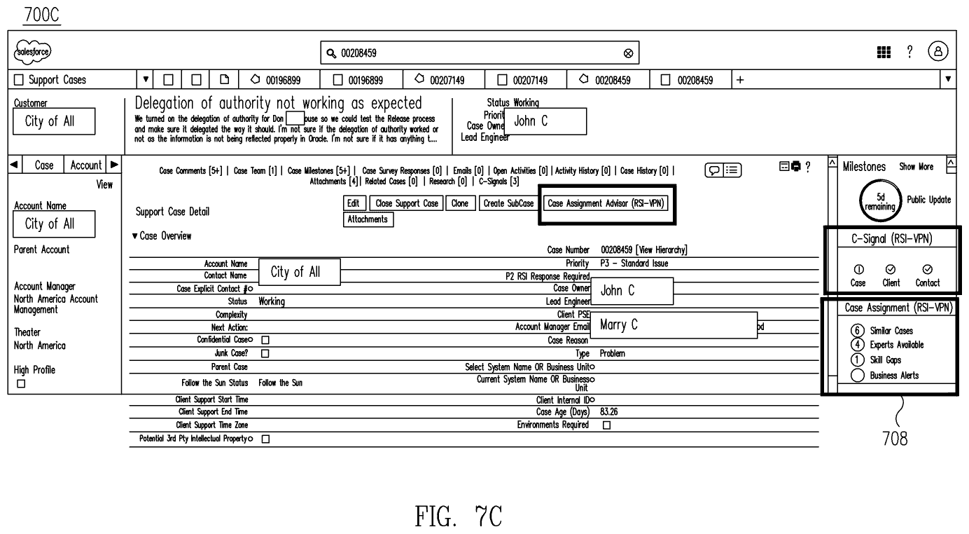

FIG. 7A is a screenshot of a dashboard user interface 700A for a case assistant system, in accordance with one embodiment.

In various embodiments, the case assistant system disclosed herein provides one or more client support professionals with a user interface that enables the client support professional to review and interact with the data provided by the RPA workers. As shown in FIG. 7A, in one embodiment, a client support professional is able to view current open case listing 702 from a dashboard interface provided by the case assistant system. In various embodiments, current open case listing 702 includes data such as, but not limited to, product line, case number, client name, client theater, case priority, case creation date, case status, client PSE, product module, product release version, case subject, and related action items.

FIG. 7B is an enlarged view 700B of a portion of the example screenshot of FIG. 7A, in accordance with one embodiment.

Referring now to FIG. 4A and FIG. 7B together, in one embodiment, action items 706 are provided to the client support professional for each case subject item 704. In one embodiment, action items 706 allow the client support professional to interact with the data provided by the RPA workers discussed above. For example, in one embodiment action items 706 includes a link to view data related to cases similar to the current open case represented by case subject item 704. In one embodiment the similar case data includes the ranked similar case data generated at 414 of FIG. 4A. In one embodiment, action items 706 includes a link to view data related to skilled experts associated with the current open case represented by case subject item 704. In one embodiment, the experts data includes the ranked skilled experts data generated at 436 of FIG. 4A. In one embodiment, action items 706 includes a link to view data related to business alerts associated with the current open case represented by case subject item 704. In one embodiment, the business alerts data includes the business exceptions data generated at 454 of FIG. 4A.

FIG. 7C is an example screenshot 700C of a case assistant widget being utilized as part of a larger client service system, in accordance with one embodiment. In one embodiment, the links to similar case data, skilled experts data and business alerts generated by the RPA workers are provided via case assistant widget 708, which in some embodiments, is a widget that can be incorporated as part of a larger client service system.

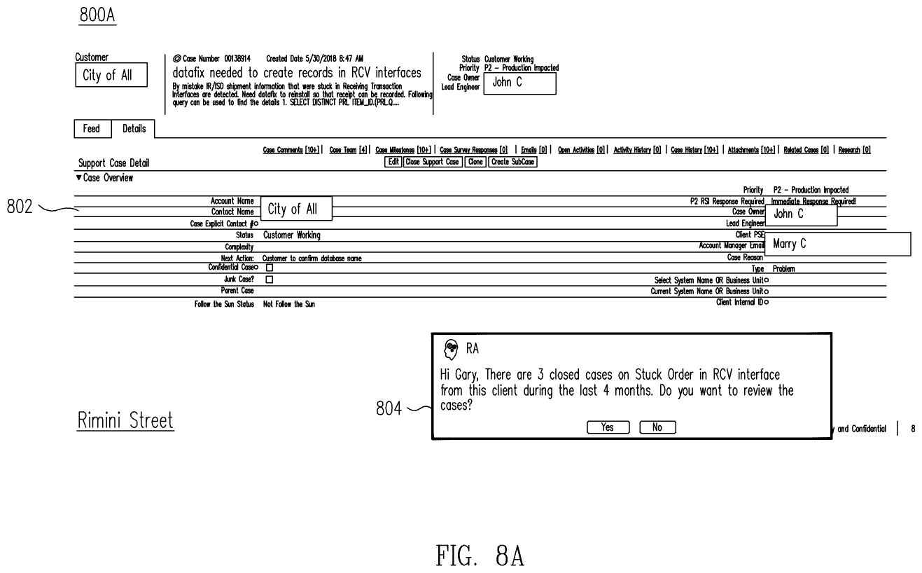

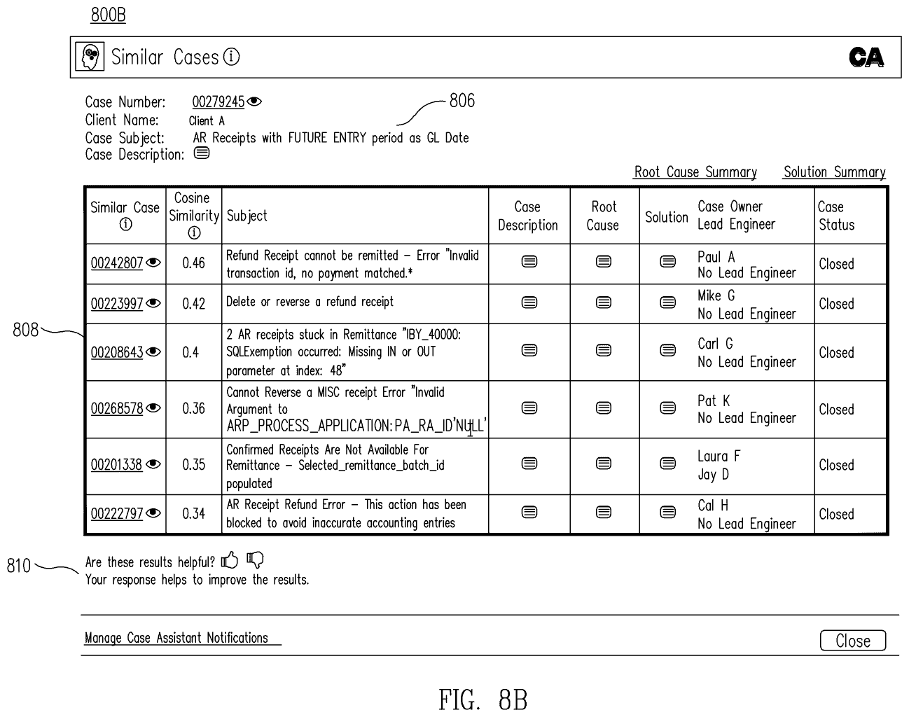

FIG. 8A is a screenshot 800A of an alert system associated with a document similarity finder, in accordance with one embodiment.

In one embodiment, when cases similar to a current open case, such as current open case 802 are found by the RPA workers, an alert such as similar cases alert 804 may be automatically provided to the client support professional working current open case 802.

FIG. 8B is a screenshot 800B of a listing of similar cases generated by a document similarity finder, in accordance with one embodiment.

In one embodiment, the client support professional may be presented with ranked similar case data 808 for cases found by the RPA workers to be similar to the current open case represented by current open case data 806. In some embodiments, the ranked similar case data 808 includes data such as, but not limited to, the similar case number, the cosine similarity value generated for each similar case by the document similarity finder, the subject of the similar case, a link to a description of the similar case, a link to data associated with the root cause of the similar case, a link to data associated with the solution to the problem resolved for the similar case, data related to the client support professionals that were responsible for resolving the similar case, as well as the status of the similar case. In one embodiment, the client support professional is also provided with similar case feedback mechanism 810, which allows the client support professional to provide feedback on the case results, which can then be incorporated into the training data utilized by the RPA workers to train the document similarity finder ML models.

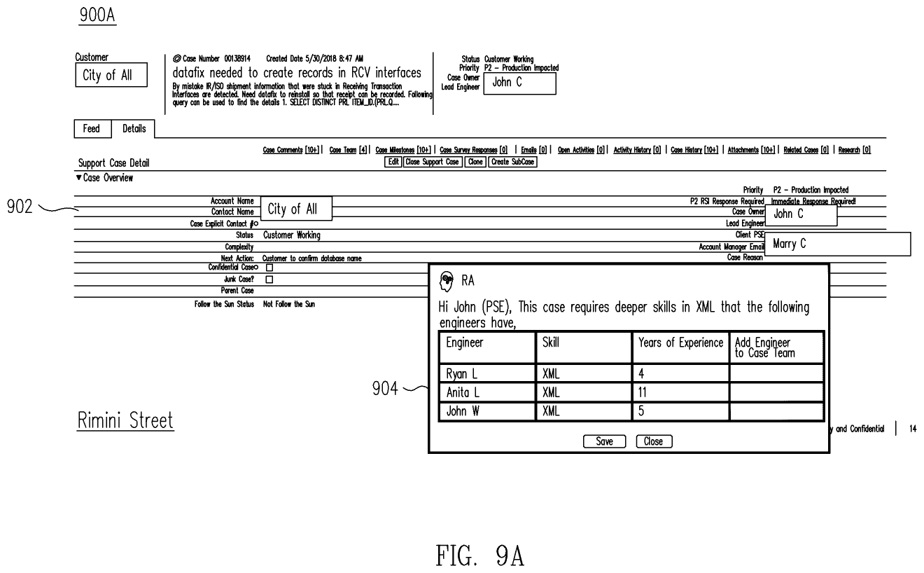

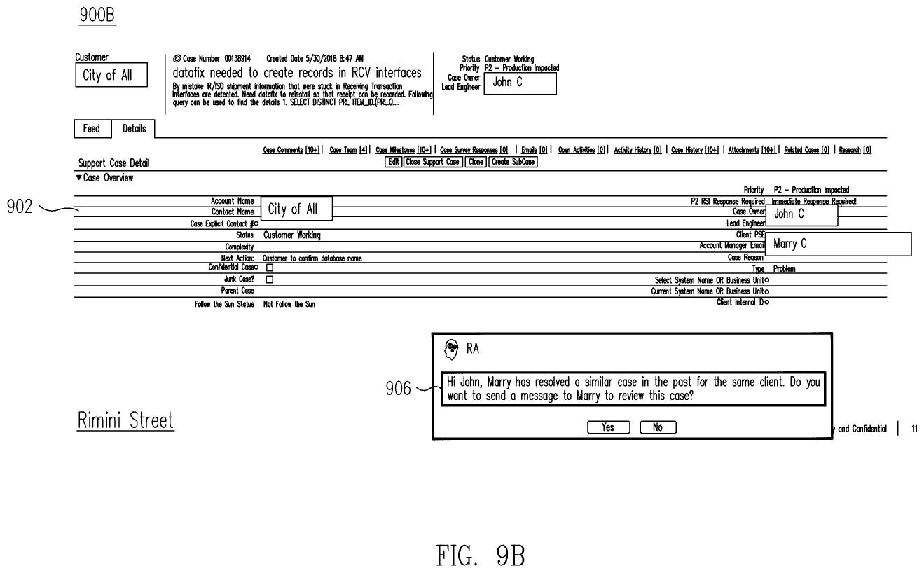

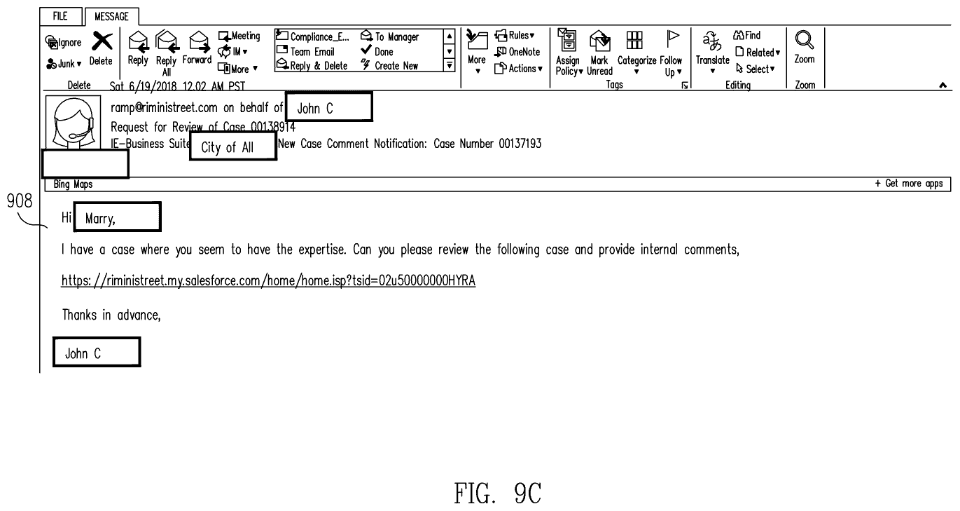

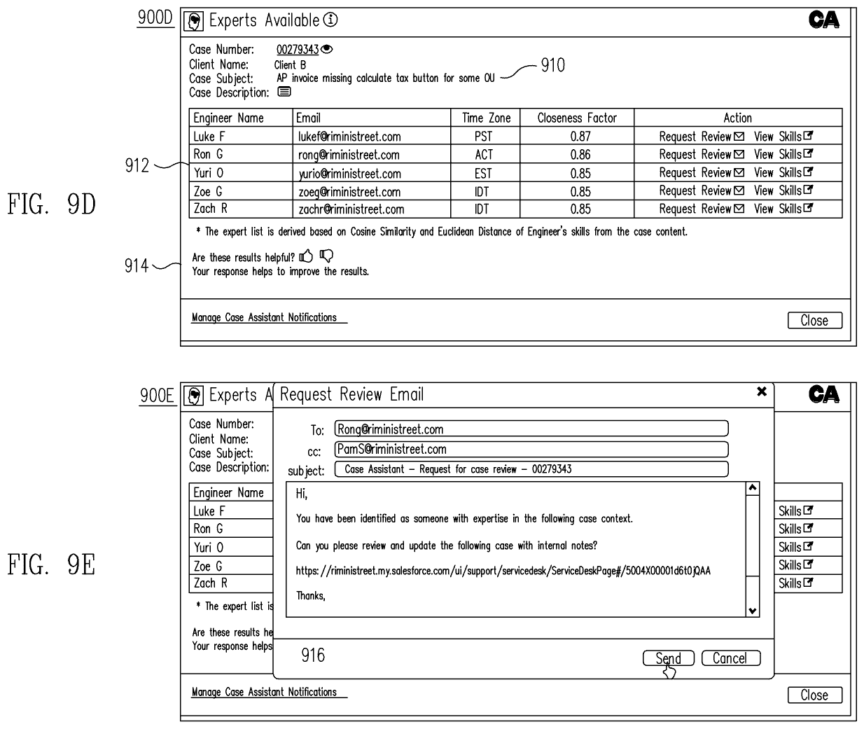

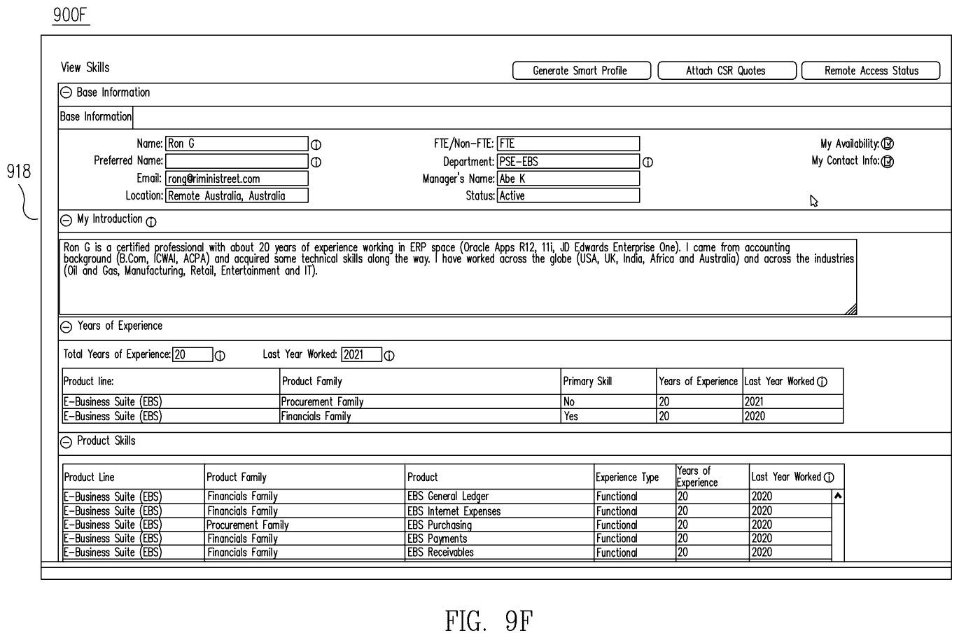

FIG. 9A and FIG. 9B are screenshots 900A and 900B of an alert system associated with a skilled expert finder, in accordance with one embodiment.

As shown in FIG. 9A, in one embodiment, when skill gaps for a current open case, such as current open case 902, are found by the RPA workers, an alert such as skill gaps alert 904 may be automatically provided to the client support professional working current open case 902.

As shown in FIG. 9B, in one embodiment, when skilled experts for cases similar to a current open case, such as current open case 902, are found by the RPA workers, an alert such as skilled expert alert 906 may be automatically provided to the client support professional working current open case 902.

FIG. 9C is a screenshot of an interface 900C for initiating collaboration with skilled experts, in accordance with one embodiment.

Referring now to FIG. 9B and FIG. 9C together, in one embodiment, once an alert such as skilled expert alert 906 is presented to the client support professional working current open case 902, if the client support professional wishes to contact the recommended skilled expert, they may be provided with a skilled expert collaboration message generator 908, which in one embodiment automatically populates a message for sending to the skilled expert to initiate collaboration.

FIG. 9D is a screenshot 900D of a listing of available skilled experts generated by a skilled expert finder, in accordance with one embodiment.

In one embodiment, the client support professional may be presented with ranked skilled experts data 912 for skilled experts found by the RPA workers to be most skilled with cases similar to the current open case represented by current open case data 910. In some embodiments, the ranked skilled experts data 912 includes data such as, but not limited to, the name of the skilled expert, the email of the skilled expert, the time zone of the skilled expert, the closeness factor generated for each skilled expert by the skilled expert finder, a link to initiate collaboration with the skilled expert, and a link to view detailed skills data associated with the skilled expert. In one embodiment, the client support professional is also provided with skilled experts feedback mechanism 914, which allows the client support professional to provide feedback on the experts results, which can then be incorporated into the training data utilized by the RPA workers to train the skilled expert finder ML models.

FIG. 9E is a screenshot 900E of an interface for initiating collaboration with available skilled experts, in accordance with one embodiment.

Referring now to FIG. 9D and FIG. 9E together, in one embodiment, once ranked skilled experts data 912 is presented to the client support professional working current open case 910, if the client support professional wishes to contact one of the recommended skilled experts, they may utilize the provided link to request review by the skilled expert, which, in one embodiment, provides the client support professional with a skilled expert collaboration message generator 916, which in one embodiment automatically populates a message for sending to the skilled expert to initiate collaboration.

FIG. 9F is a screenshot 900F of an interface for viewing the skills of available skilled experts, in accordance with one embodiment.

Referring now to FIG. 9D and FIG. 9F together, in one embodiment, if the client support professional wishes to view detailed skills data associated with one of the skilled experts represented by ranked skills experts data 912, they may utilize the provided link to open an interface for viewing details of the skilled expert. In some embodiments, skilled expert details 918 include details such as, but not limited to, expert name, email, location, status, biography, as well as data related to years of experience with a variety of different product lines, product families, products, etc.

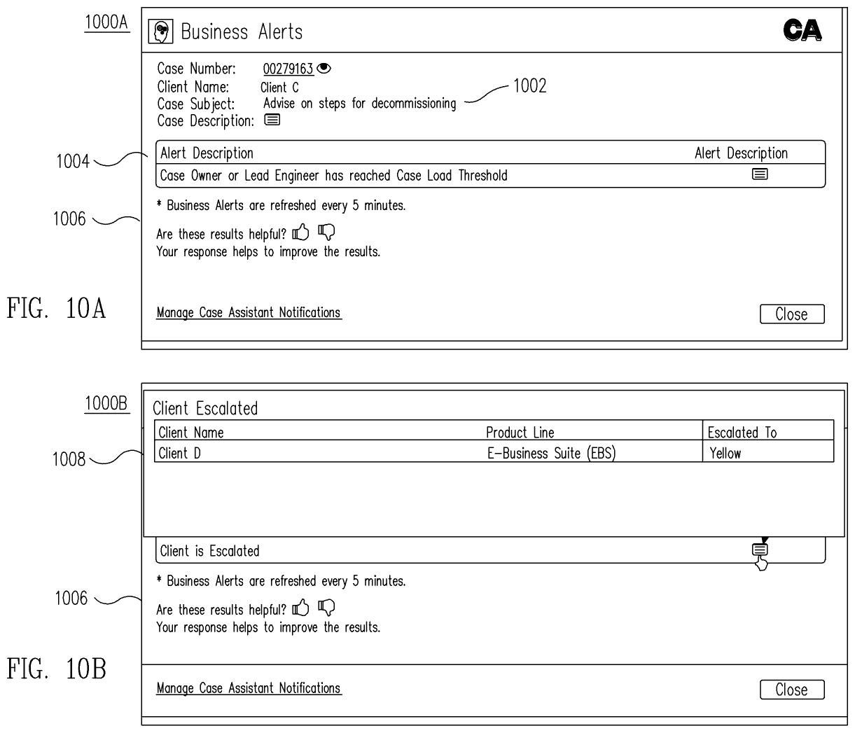

FIG. 10A and FIG. 10B are screenshots 1000A and 100B of business exception alerts generated by a business exception finder, in accordance with one embodiment.

As shown in FIG. 10A, in one embodiment, the client support professional may be presented with business exceptions data 1004 for business execution exceptions found by the RPA workers for the current open case represented by current open case data 1002. In some embodiments, the business exceptions data 1004 includes data such as, but not limited to, a description of the alert type, and a link for viewing additional information about the alert.

As shown in FIG. 10B, in various embodiments, the additional information 1008 provided about the business exceptions represented by business exceptions data 1004 may include data such as, but not limited to, client name, product line, escalation level, etc. In one embodiment, the additional information 1008 provided to the client support professional is dependent upon the type of business alert.

In one embodiment, the client support professional is also provided with business alerts feedback mechanism 1006, which allows the client support professional to provide feedback on the business exceptions results, which can then be incorporated into the training data utilized by the RPA workers to train the business exception finder ML models.

In one embodiment, once the client support professional is provided with data related to one or more of similar cases, skilled experts, and business exceptions at 456, the client support professional utilizes this data to more rapidly and successfully resolve client cases, and process flow proceeds to END 458, wherein the process 400A for providing case assistance to client support professionals is exited to await new data and/or instructions.

In various embodiments, the method and system disclosed herein allows case data, client data, employee data, and skills data to be consolidated from multiple data sources into one platform. The case assistant may be continuously running in the background with focused RPA workers always trying to assist the support professionals within defined constraints, such as, but not limited to, looking for the cases from the same client. In various embodiments, the method and system disclosed herein uses a combination of data mining, data processing, natural language processing, machine learning models and processes, and performance optimization to allow for both real time processing and scheduled processing. In one embodiment, the case assistant is able to dynamically select the machine learning processing method that is most suited for the document similarity finding, depending on a variety of case data factors. In one embodiment, the number of case assistant workers is able to be scaled up and down based on case logging patterns, including factors such as the number of currently open cases. In one embodiment, the RPA continuous processing functionality is able to be navigated based on defined constraints from business and governance. In one embodiment, the business context of open and closed cases is able to be enriched from continuous feedback and machine learning techniques to reach precision of results in a very short time. In one embodiment, the stop word removal process is able to be enriched from continuous feedback and machine learning techniques to improving the efficiency and accuracy of open and closed case context formulation.

While the embodiments of the present disclosure provide highly efficient, effective, and versatile systems and methods for utilizing robotic process automation to provide real-time assistance to client support professionals, the disclosed embodiments of systems and methods for providing real-time assistance to client support professionals, do not encompass, embody, or preclude other forms of innovation in the area of process automation.

In addition, the disclosed embodiments of systems and methods for utilizing robotic process automation to provide real-time assistance to client support professionals, are not abstract ideas for at least several reasons.

First, as noted above, a service provider that provides a variety of support services to clients can potentially have hundreds of clients, with data repositories containing thousands of case records associated with jobs performed for each of those clients. Efficient resolution of open cases often hinges on being able to rapidly identify closed case records that are similar to open case records. Further, each case may require numerous skills to resolve, and each client support professional can potentially have numerous specialized skills, and/or experience with numerous specific products, modules, and/or features and/or capabilities associated with those products and modules for which the business provides support and employees. Given that each client support professional can have potentially hundreds of skills associated with potentially hundreds of products and modules, it is often the case that a single client support professional's skill set can include hundreds, or even thousands, of individual skills. Consequently, identifying closed cases that are similar to open cases, identifying the skills necessary to resolve open cases, and identifying the client support professionals best suited, i.e., most qualified, to support a given task, project, or case can rapidly become a complicated and daunting task, especially considering the hundreds, thousands, and/or millions of data points required to perform the relevant analytical assessments.

Indeed, the problem can be so complex that it is not possible for a human being to accurately identify business context similarity across thousands of documents, and comprehend the interaction and relationships between the skill sets of multiple, even hundreds, of employees, each having potentially hundreds, or even thousands, of individual skills, and the requirements of multiple, even hundreds, of tasks, projects, or cases for potentially hundreds of clients of the business, each having potentially hundreds, or even thousands, of skill set requirements and contract performance requirements and limitations. The result is a problem complexity that makes it impossible for a human being to recognize significant relationships and interconnections between factors necessary to most effectively and efficiently provide real-time case assistance to client support professionals.

In contrast, the disclosed embodiments utilize machine learning techniques in a unique way to identify similarities between case documents, identify skilled experts, and efficiently provide this information to business support professionals in real time, in ways a human being is not capable of doing, and based on relationships a human being could not possibly discern. Consequently, the disclosed systems and methods for utilizing robotic process automation to effectively and efficiently provide real-time assistance to client support professionals are not abstract ideas because they are not merely an idea itself and cannot be performed mentally or using pen and paper.

Second, the disclosed systems and methods for utilizing robotic process automation to effectively and efficiently provide real-time assistance to client support professionals are not abstract ideas because they are not a fundamental economic practice (e.g., are not merely creating a contractual relationship, hedging, mitigating a settlement risk, etc.).

Third, although mathematics may be used in the disclosed systems and methods for utilizing robotic process automation to effectively and efficiently provide real-time assistance to client support professionals, the disclosed and claimed systems and methods are not abstract ideas because they are not simply a mathematical relationship/formula.

In addition, as discussed above, the disclosed method and system for utilizing robotic process automation to effectively and efficiently provide real-time assistance to client support professionals provides consolidated, normalized, and more focused data which provides for the processing and storage of consolidated and more accurate data, and minimizes the processing of irrelevant, inaccurate, or erroneous data. Therefore, using the disclosed embodiments, unnecessary data analysis, transfer, and storage is avoided. Consequently, using the disclosed method and system for effectively and efficiently provide real-time assistance to client support professionals results in more efficient use of human and non-human resources, fewer processor cycles being utilized, reduced memory utilization, and less communications bandwidth being utilized to relay data to, and from, backend systems and various systems and parties. As a result, computing systems are transformed into faster, more efficient, and more effective computing systems by implementing the disclosed embodiments.

In addition, the disclosed embodiments represent an ordered combination of operations, including integration, normalization, and machine learning processing of data that together amount to significantly more than any abstract idea and represent an inventive concept and technological advancement.

The present invention has been described in particular detail with respect to specific possible embodiments. Those of ordinary skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, or protocols. Further, the system or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of ordinary skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

As discussed in more detail above, using the above embodiments, with little or no modification and/or input, there is considerable flexibility, adaptability, and opportunity for customization to meet the specific needs of various parties under numerous circumstances.

Some portions of the above description present the features of the present invention in terms of processes/algorithms and symbolic representations of operations, or algorithm-like representations, of operations on information/data. These algorithmic or algorithm-like descriptions and representations are the means used by those of ordinary skill in the art to most effectively and efficiently convey the substance of their work to others of skill in the art. These operations, while described functionally or logically, are understood to be implemented by computer programs or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as, but not limited to, “activating”, “accessing”, “adding”, “aggregating”, “alerting”, “applying”, “analyzing”, “associating”, “calculating”, “capturing”, “categorizing”, “classifying”, “comparing”, “creating”, “defining”, “detecting”, “determining”, “distributing”, “eliminating”, “encrypting”, “extracting”, “filtering”, “forwarding”, “generating”, “identifying”, “implementing”, “informing”, “monitoring”, “obtaining”, “posting”, “processing”, “providing”, “receiving”, “requesting”, “saving”, “sending”, “storing”, “substituting”, “transferring”, “transforming”, “transmitting”, “using”, etc., refer to the action and process of a computing system or similar electronic device that manipulates and operates on data represented as physical (electronic) quantities within the computing system memories, resisters, caches or other information storage, transmission or display devices.

The present invention also relates to an apparatus or system for performing the operations described herein. This apparatus or system may be specifically constructed for the required purposes, or the apparatus or system can comprise a system selectively activated or configured/reconfigured by a computer program stored on a non-transitory computer readable medium for carrying out instructions using a processor to execute a process, as discussed or illustrated herein that can be accessed by a computing system or other device.

Those of ordinary skill in the art will readily recognize that the algorithms and operations presented herein are not inherently related to any particular computing system, computer architecture, computer or industry standard, or any other specific apparatus. Various systems may also be used with programs in accordance with the teaching herein, or it may prove more convenient/efficient to construct more specialized apparatuses to perform the required operations described herein. The required structure for a variety of these systems will be apparent to those of ordinary skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the invention as contemplated by the inventors at the time of filing.

The present invention is well suited to a wide variety of computer network systems operating over numerous topologies. Within this field, the configuration and management of large networks comprise storage devices and computers that are communicatively coupled to similar or dissimilar computers and storage devices over a private network, a LAN, a WAN, a private network, or a public network, such as the Internet.

It should also be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the figures, or as discussed or illustrated herein, are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

What is claimed is:

1. A computing system implemented method for training Robotic Process Automation (RPA) workers to identify similarities in large data sets comprising:
utilizing one or more machine learning processes to train one or more RPA workers to analyze large data sets for the purposes of optimizing the ability of the RPA workers to accurately identify similarities between two or more distinct data sets, wherein training the one or more RPA workers includes:
training the one or more RPA workers to initiate and perform a data collector sub-process, wherein the data collector sub-process is configured to locate and aggregate a first data set containing current open case data and a second data set containing historical closed case data;
training the one or more RPA workers to initiate and perform a tokenizer sub-process, wherein the tokenizer sub-process receives the first data set and the second data set from the data collector sub-process and is configured to execute a parsing operation on the first data set and the second data set to generate tokenized current open case vector data and tokenized closed case vector data;
training the one or more RPA workers to initiate and perform a two-pass stop word remover sub-process, wherein the two-pass stop word remover sub-process analyzes tokens of the tokenized current open case vector data and the tokenized closed case vector data to identify and separate tokens that are useful for determining context of case data from tokens that are not useful for determining context of case data to build one or more dynamically updating token identification data lists;
training the one or more RPA workers to initiate and perform a relevance finder sub-process, which is configured to receive and analyze one or more dynamically updating token identification data lists and, upon completion of analysis, is further configured to execute assignment of relevance weights to each token listed on the dynamically updating token identification data list; and
training the one or more RPA workers to initiate and perform a similarity finder sub-process, which receives token weighting data from the relevance finder sub-process and utilizes the weighting data and one or more distinct similarity processes to generate a list of historical closed cases that are similar to a current open case represented by the current open case data.

2. The computing system implemented method of claim 1, wherein a first pass of the two-pass stop word remover sub-process includes utilizing Natural Language Tool Kit (NLTK) functions to remove tokens that are not useful for determining case context from the tokenized case vector data.

3. The computing system implemented method of claim 1, wherein a second pass of the two-pass stop word remover sub-process includes:
training the one or more RPA workers to build one or more dynamically updating token identification data lists, which identify tokens that are not useful for determining case context, wherein the identified not useful tokens are tokens which the first pass of the two-pass stop word remover sub-process failed to remove from the tokenized case vector data;
training the one or more RPA workers to build one or more dynamically updating token identification data lists, which identify tokens that are useful for determining case context, wherein the identified useful tokens are tokens which the first pass of the stop word remover sub-process removed from the tokenized case vector data erroneously; and
utilizing the one or more dynamically updating token identification data lists to refine the results of the first pass of the stop word remover sub-process.

4. The computing system implemented method of claim 3 wherein the one or more RPA workers are trained to build the one or more dynamically updating token identification data lists in real-time.

5. The computing system implemented method of claim 4, wherein the relevance finder sub-process includes building one or more customized relevance finder processes.

6. The computing system implemented method of claim 5, wherein building one or more customized relevance finder processes includes one or more of:
training the one or more RPA workers to utilize TF-IDF techniques to identify tokens in the one or more dynamically updating token identification data lists that should be assigned a higher or lower relevance value than other tokens in the one or more dynamically updating token identification data lists;
training the one or more RPA workers to identify context of tokens in the one or more dynamically updating token identification data lists; and
training the one or more RPA workers to identify tokens in the one or more dynamically updating token identification data lists that should be assigned a higher or lower relevance value than other tokens in the one or more dynamically updating token identification data lists based on the identified context of the tokens.

7. The computing system implemented method of claim 1 wherein the similarity finder sub-process is further configured to determine a similarity ranking for each historical closed case in the list of similar historical closed cases.

8. The computing system implemented method of claim 1, wherein the one or more similarity processes include:
a Cosine Similarity algorithm;
a Jaccard Similarity algorithm; and
an LSA Similarity algorithm.

9. The computing system implemented method of claim 8, wherein a similarity process is dynamically selected based on one or more of:
a context of the current open case;
a context of the historical closed case;
a number of current and historic case documents being compared;
a size of each of the current and historic case documents being compared;
a number of pages in each of the current and historic case documents being compared;
a number of paragraphs in each of the current and historic case documents being compared;
a number of words in each of the current and historic case documents being compared;
a file type of each of the current and historic case documents being compared; and
a number of relevant words that were found for each of the current and historic case documents being compared.

10. A system for training Robotic Process Automation (RPA) workers to identify similarities in large data sets comprising:
at least one processor; and at least one memory coupled to the at least one processor, the at least one memory having stored therein instructions which, when executed by the at least one processor, perform a process including:
training the one or more RPA workers to initiate and perform a data collector sub-process, wherein the data collector sub-process is configured to locate and aggregate a first data set containing current open case data and a second data set containing historical closed case data;
training the one or more RPA workers to initiate and perform a tokenizer sub-process, wherein the tokenizer sub-process receives the first data set and the second data set from the data collector sub-process and is configured to execute a parsing operation on the first data set and the second data set to generate tokenized current open case vector data and tokenized closed case vector data;
training the one or more RPA workers to initiate and perform a two-pass stop word remover sub-process, wherein the two-pass stop word remover sub-process analyzes tokens of the tokenized current open case vector data and the tokenized closed case vector data to identify and separate tokens that are useful for determining context of case data from tokens that are not useful for determining context of case data to build one or more dynamically updating token identification data lists;
training the one or more RPA workers to initiate and perform a relevance finder sub-process, which is configured to receive and analyze one or more dynamically updating token identification data lists and, upon completion of analysis, is further configured to execute assignment of relevance weights to each token listed on the dynamically updating token identification data list; and
training the one or more RPA workers to initiate and perform a similarity finder sub-process, which receives token weighting data from the relevance finder sub-process and utilizes the weighting data and one or more distinct similarity processes to generate a list of historical closed cases that are similar to a current open case represented by the current open case data.

11. The system of claim 10, wherein a first pass of the two-pass stop word remover sub-process includes utilizing Natural Language Tool Kit (NLTK) functions to remove tokens that are not useful for determining case context from the tokenized case vector data.

12. The system of claim 10, wherein a second pass of the two-pass stop word remover sub-process includes:
training the one or more RPA workers to build one or more dynamically updating token identification data lists, which identify tokens that are not useful for determining case context, wherein the identified not useful tokens are tokens which the first pass of the two-pass stop word remover sub-process failed to remove from the tokenized case vector data;
training the one or more RPA workers to build one or more dynamically updating token identification data lists, which identify tokens that are useful for determining case context, wherein the identified useful tokens are tokens which the first pass of the stop word remover sub-process removed from the tokenized case vector data erroneously; and
utilizing the one or more dynamically updating token identification data lists to refine the results of the first pass of the stop word remover sub-process.

13. The system of claim 12 wherein the one or more RPA workers are trained to build the one or more dynamically updating token identification data lists in real-time.

14. The system of claim 13, wherein the relevance finder sub-process includes building one or more customized relevance finder processes.

15. The system of claim 14, wherein building one or more customized relevance finder processes includes one or more of:
training the one or more RPA workers to utilize TF-IDF techniques to identify tokens in the one or more dynamically updating token identification data lists that should be assigned a higher or lower relevance value than other tokens in the one or more dynamically updating token identification data lists;
training the one or more RPA workers to identify context of tokens in the one or more dynamically updating token identification data lists; and
training the one or more RPA workers to identify tokens in the one or more dynamically updating token identification data lists that should be assigned a higher or lower relevance value than other tokens in the one or more dynamically updating token identification data lists based on the identified context of the tokens.

16. The system of claim 10 wherein the similarity finder sub-process is further configured to determine a similarity ranking for each historical closed case in the list of similar historical closed cases.

17. The system of claim 10, wherein the one or more similarity processes include:
a Cosine Similarity algorithm;
a Jaccard Similarity algorithm; and
an LSA Similarity algorithm.

18. The system of claim 17, wherein a similarity process is selected from the one or more similarity processes dynamically during data processing, and further wherein the selected similarity process is used to generate the list of historical closed cases that are similar to the current open case.

19. The system of claim 18, wherein the selected similarity process is dynamically selected based on one or more of:
a context of the current open case;
a context of the historical closed case;
a number of current and historic case documents being compared;
a size of each of the current and historic case documents being compared;
a number of pages in each of the current and historic case documents being compared;
a number of paragraphs in each of the current and historic case documents being compared;
a number of words in each of the current and historic case documents being compared;
a file type of each of the current and historic case documents being compared; and
a number of relevant words that were found for each of the current and historic case documents being compared.

20. A computing system implemented method for optimizing the ability of one or more Robotic Process Automation (RPA) workers accurately identify similarities between two or more distinct data sets comprising:
training the one or more RPA workers to perform a data collector sub-process, wherein the data collector sub-process is configured to locate and aggregate a first data set containing current open case data and a second data set containing historical closed case data;
training the one or more RPA workers to perform a tokenizer sub-process to generate tokenized current open case vector data and tokenized closed case vector data;
training the one or more RPA workers to perform a two-pass stop word remover sub-process, wherein the two-pass stop word remover sub-process identifies and separates tokens that are useful for determining context of case data from tokens that are not useful for determining context of case data to build one or more token identification data lists;
training the one or more RPA workers to perform a relevance finder sub-process, which is configured to execute assignment of relevance weights to each token listed on the token identification data list; and
training the one or more RPA workers to perform a similarity finder sub-process, which generates a list of historical closed cases that are similar to a current open case represented by the current open case data.
